(19) United States
(12) Patent Application Publication
(10) Pub. No.: US 2011/0318533 A1
(43) Pub. Date: Dec. 29, 2011

(54) METHOD OF DUPLICATING TEXTURE PATTERN ON OBJECT'S SURFACE BY NANO IMPRINTING AND ELECTROFORMING AND PATTERNED DUPLICATION PANEL USING THE SAME

(75) Inventors: Kyung Wook LEE, Ansan (KR); Kyung Yul LEE, Bucheon (KR); Jun Sang JEONG, Daejeon (KR); Soo Han KIM, Seoul (KR)

(73) Assignee: EMOT CO., LTD., Ansan (KR)

(21) Appl. No.: 13/226,631

(22) Filed: Sep. 7, 2011

Related U.S. Application Data
(63) Continuation-in-part of application No. 12/655,030, filed on Dec. 22, 2009.

(30) Foreign Application Priority Data
Jun. 28, 2007 (KR) 10-2007-0064153
Sep. 8, 2010 (KR) 10-2010-0088038
May 18, 2011 (KR) 10-2011-0046879

(51) Int. Cl. B32B 3/00; B29C 33/42; B29C 33/38; C25D 1/10

(52) U.S. Cl. 428/141; 205/70; 264/219

(57) ABSTRACT

Provided is a method of duplicating a nano-pattern texture of the surface of an object through electroforming using an imprint mold, including selecting the object having the surface texture to be duplicated; disposing the selected object and pre-treating the surface thereof; nano-imprinting the surface of the pretreated object, thus duplicating it on a plastic mold; metalizing the surface of the plastic mold through vapor deposition, and performing electroforming, thus manufacturing metal module master molds; trimming the edges of the metal module master molds, performing micro-processing, connecting the metal module master molds, and then performing electroforming, thus manufacturing a large-area metal unit master mold; and electroforming the metal unit master mold, thus producing a duplicate having the surface texture, thus exhibiting an effect in which the skin of a selected natural object can be duplicated on metal having a uniform thickness.

### CROSS REFERENCE TO RELATED APPLICATIONS

This application is a continuation-in-part of U.S. patent application Ser. No. 12/655,030, filed on Dec. 22, 2009, which claims priority to Korean Patent Application No. 10-2007-0064153, filed on Jun. 28, 2007. This application also claims priority under 35 U.S.C. 119(a) to Korean Patent Application Nos. 10-2011-0046879, filed on May 18, 2011, and 10-2010-0088038, filed on Sep. 8, 2010, the disclosures of which are incorporated herein by reference in their entireties.

### BACKGROUND

1. Field

The present invention relates to the duplication of the surface of an object, and more particularly, to a method of duplicating the pattern of the surface of an object, by duplicating the fine and beautiful surface of an object, which is to be duplicated, using nano-imprinting and electroforming, thus realizing an original texture.

2. Description of the Related Art

Generally, the skins or surfaces of objects naturally present in the natural world, such as plants, insects, leather, minerals, trees, fiber, and fabric, have very beautiful and soft structures and textures and exhibit natural colors, and thus research and development into the application thereof to decorate the outer appearances of mass-produced industrial products is ongoing. In particular, because mobile communication portable terminals, PDAs, or notebook computers, which are expensive and are manufactured to be luxurious, should always be carried, the surface thereof is required to have low abrasion and be easy to maintain, and further, because they are shown to other persons, the outer appearance thereof is required to have a soft and luxurious texture or feel.

It is typical for metal material to be used to decrease the abrasion of a surface and for natural material to be used to impart a soft feel. Therefore, in order to develop an outer appearance or surface imparting a soft feel using metal material having low abrasion, lots of time and money are invested. Meanwhile, duplication methods in plastic are being developed.

The case where an object having a predetermined pattern to be duplicated is soft enables complicated and fine surface duplication but makes it difficult to manufacture a mold for use in such duplication. Further, although an etching process including photolithography and chemical etching may be applied to produce complicated and fine patterns, it is unsuitable for mass production.

In the case of plastic dolls, wire telephones, automobiles or the like, a molding technique is applied at high pressure using a press so that the same shape or outer appearance is mass-duplicated, whereas, in the case of the skin of insects, plants, processed leather, minerals, fiber, and fabric, repeated duplication of a fine surface texture on the nanometer scale cannot be realized by the magnitude of the pressure of the press, and thus, desired colors and patterns must be realized through additional surface treatment.

However, such additional surface treatment is also problematic in that it is difficult to realize a good texture and structure, as in the skin of the insects, plants, processed leather, minerals, fiber, and fabric.

### SUMMARY

The present invention provides a method of duplicating the texture of the surface of an object, such as an animal, plant, mineral, fabric, or wood, on metal or plastic to thus realize the same texture, and specifically, a method of duplicating the pattern of the surface of an object so that metal or plastic is imparted with the surface texture of the selected object using a nano-imprint plastic mold and an electroformed master mold.

In addition, the present invention provides a method of duplicating the pattern of the surface of an object by scanning the surface of an object to be duplicated, performing two-dimensional (2D) or three-dimensional (3D) micro- or nano-technology, thus forming a standard pattern, and connecting the edges of nano-imprint module master molds to impart the standard pattern, thus forming a large-area master mold having a desired size.

According to the present invention, a method of duplicating the surface texture of an object using an imprint mold may comprise selecting the object having the surface texture to be duplicated: disposing the selected object and pretreating the surface thereof; nano-imprinting the surface of the pretreated object, thus duplicating it on a plastic mold; metalizing the surface of the plastic mold through vapor deposition and performing electroforming, thus manufacturing metal module master molds; trimming the edges of the metal module master molds, performing micro-processing, connecting the metal module master molds, and then performing electroforming, thus manufacturing a large-area metal unit master mold; and electroforming the metal unit master mold, thus producing a duplicate having the surface texture.

In addition, a method of duplicating the surface texture of an object using an imprint mold may comprise selecting the object, pretreating the surface thereof, nano-imprinting the pretreated surface to manufacture a plastic mold, which is then metalized through vapor deposition, and performing electroforming, thus manufacturing metal module master molds; trimming the edges of the metal module master molds, performing 2D or 3D micro-processing to impart a standard pattern set through surface scanning, connecting the metal module master molds, and performing electroforming, thus manufacturing a large-area metal unit master mold; and producing a duplicate having the surface texture from the unit master mold, and coloring and coating it.

According to another aspect of the present invention, a method of duplicating a pattern texture of a surface of an object may include a) manufacturing a rolling mold having a width of 10 centimeters to 120 centimeters and a circumferential length of 10 centimeters to 240 centimeters, with a surface thereof formed with a micro pattern; b) mounting the rolling mold to a rolling roller; c) measuring a thickness of a metal sheet, and setting a gap of the rolling rollers in such a way that a pitch of the micro pattern is 5 μm to 20 mm, and a depth is 1 μm to 330 μm; and d) performing rolling of the metal sheet by the rolling roller under the set gap of the rolling roller.

In addition, according to other aspect of the present invention, there is provided a metal panel including a surface with a micro pattern or design, wherein ten-point average roughness (Rz) of the micro pattern or design formed on the surface is 10 μm to 40 μm.

According to other aspect of the present invention, there is provided a metal panel including a surface with a micro pattern or design, wherein median average roughness (Ra) of the micro pattern or design formed on the surface is 3 μm to 8 μm.

Further, according to other aspect of the present invention, there is provided a metal panel including a surface with a micro pattern or design, wherein ten-point average roughness (Rz) of the micro pattern or design formed on the surface is 10 μm to 40 μm, and median average roughness (Ra) of the micro pattern or design formed on the surface is 3 μm to 8 μm.

According to the present invention, the pattern texture of the surface of the selected object is nano-imprinted, thus manufacturing module master molds, which are then subjected to 2D or 3D edge processing and electroforming, thus manufacturing a large-area unit master mold, from which the same texture can then be duplicated on metal or plastic, thus realizing industrial availability.

In addition, according to the present invention, because electroforming is performed using the master mold having the pattern texture of the surface of the selected object, the same texture can be duplicated on metal having a uniform thickness, thus realizing industrial availability.

In addition, according to the present invention, the surface of the selected object, having a beautiful and soft texture, structure and color, can be mass-duplicated and mass-produced, thus realizing convenient effects in industrial use.

### BRIEF DESCRIPTION OF THE DRAWINGS

The above and other aspects and features of the present invention will become more apparent by describing in detail exemplary embodiments thereof with reference to the attached drawings, in which:

FIG. 1 is a flowchart sequentially illustrating the process of duplicating the nano-pattern texture of the surface of an object according to the present invention;

FIG. 2 is a photograph illustrating a large-area master mold, which is manufactured by subjecting a plurality of module master molds, which are imprinted with the surface of natural leather according to an embodiment of the present invention, to edge processing;

FIG. 3 is a photograph, magnified 2.times., of the front surface of natural leather, which is to be molded through nano-imprinting, according to the embodiment of the present invention;

FIG. 4 is a photograph, magnified 2.times., of the mold which is nano-imprinted with the front surface of natural leather according to the embodiment of the present invention;

FIG. 5 is a photograph, magnified 2.times., of the back surface of natural leather, which is to be molded through nano-imprinting, according to the embodiment of the present invention;

FIG. 6 is a photograph, magnified 2.times., of the mold which is nano-imprinted with the back surface of natural leather according to the embodiment of the present invention;

FIG. 7 is a photograph illustrating a final product having the nano-pattern texture of the surface of the object, according to the embodiment of the present invention, duplicated thereon;

FIG. 8 is a flowchart specifically illustrating a step of manufacturing a rolling mold in the process of duplicating the pattern texture according to another embodiment of the present invention;

FIG. 9 is a view illustrating a coupling/decoupling structure of a cylindrical jig used in the step of manufacturing the rolling mold in the process of duplicating the pattern texture according to another embodiment of the present invention;

FIG. 10 is a view illustrating a polymer sheet attached to the cylindrical jig used in the step of manufacturing the rolling mold in the process of duplicating the pattern texture according to another embodiment of the present invention;

FIG. 11 is a view illustrating a step of separating the manufactured rolling mold from the cylindrical jig in the process of duplicating the pattern texture according to another embodiment of the present invention;

FIG. 12 is a view specifically illustrating a step of setting rolling conditions in the process of duplicating the pattern texture according to another embodiment of the present invention;

FIGS. 13A and 138 are photomicrographs of a surface of a metal sheet duplicated with a micro pattern of silk;

FIGS. 14A and 146 are photographs enlarging a surface of a metal sheet duplicated with a micro pattern of leather;

FIG. 15 is a photograph enlarging a surface of a metal sheet duplicated with a micro pattern of an object to be duplicated;

FIG. 16 is a view schematically illustrating a rolling step in the process of duplicating the pattern texture according to another embodiment of the present invention;

FIG. 17 is a view schematically illustrating a step of planarizing the metal sheet rolled in the process of duplicating the pattern texture according to another embodiment of the present invention;

FIG. 18 is a graph illustrating a curve of exemplary median average roughness (Ra);

FIG. 19 is a graph illustrating a curve of exemplary ten-point average roughness (Rz).

FIG. 20 is a graph illustrating a curve of exemplary photo reflection distribution;

FIG. 21 is a photograph of a pattern-duplicated metal panel duplicated with a pattern of wood's surface according to an embodiment of the present invention;

FIG. 22 is a photograph of a pattern-duplicated metal panel duplicated with a pattern of leather's surface according to an embodiment of the present invention; and

FIG. 23 is a photograph of a pattern-duplicated metal panel duplicated with a pattern of silk's surface according to an embodiment of the present invention.

### DETAILED DESCRIPTION

Aspects and features of one or more embodiments according to the present invention and methods of accomplishing the same may be understood more readily by referring to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the scope of the present invention will be defined by the appended claims and equivalents thereof. In the drawings, sizes and relative sizes of layers and regions may be exaggerated for clarity.

It will be understood that when an element or layer is referred to as being “on” another element or layer, the element or layer can be directly on another element or layer, or one or more intervening elements or layers may also be present. In contrast, when an element is referred to as being “directly on” another element or layer, there are no intervening elements or layers present. As used herein, the term “and/or” includes any and all combinations of one or more of the associated listed items.

Embodiments of the present invention are described herein with reference to plan and cross-section illustrations that are schematic illustrations of exemplary embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the invention.

Hereinafter, a detailed description will be given of a method of duplicating the nano-pattern of the surface of an object using electroforming according to the present invention, with reference to the accompanying drawings.

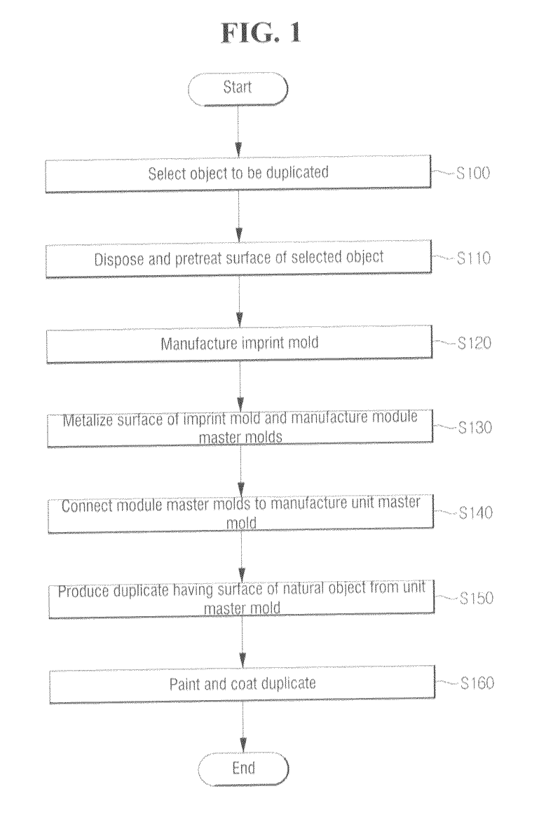

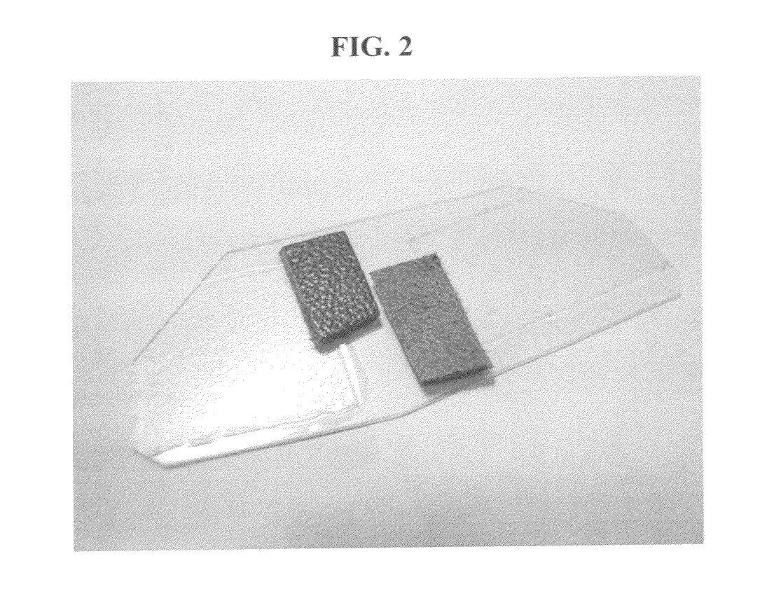

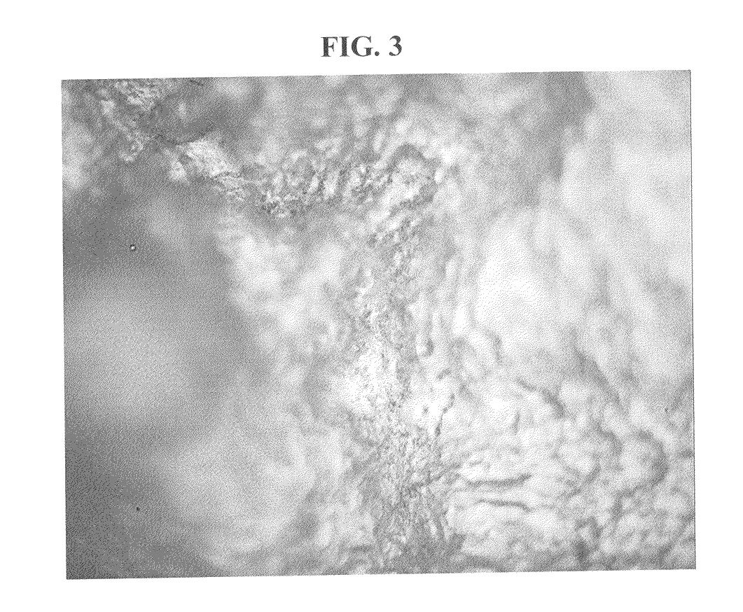

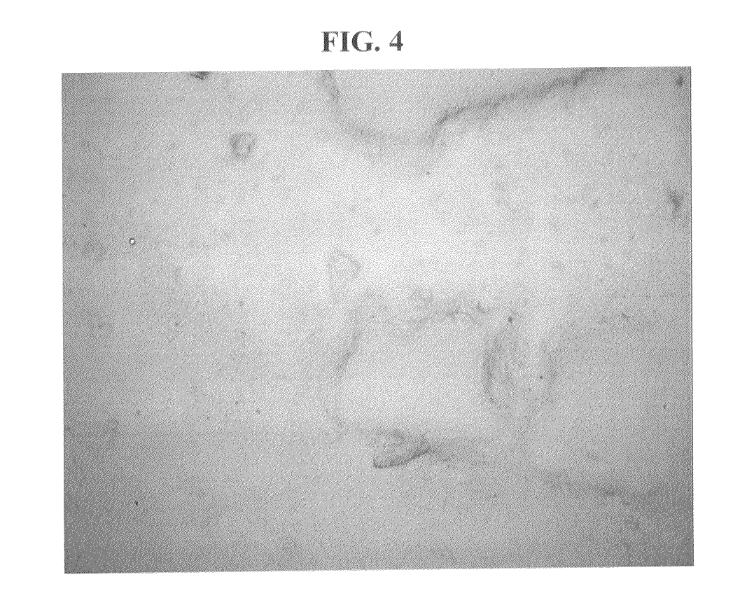

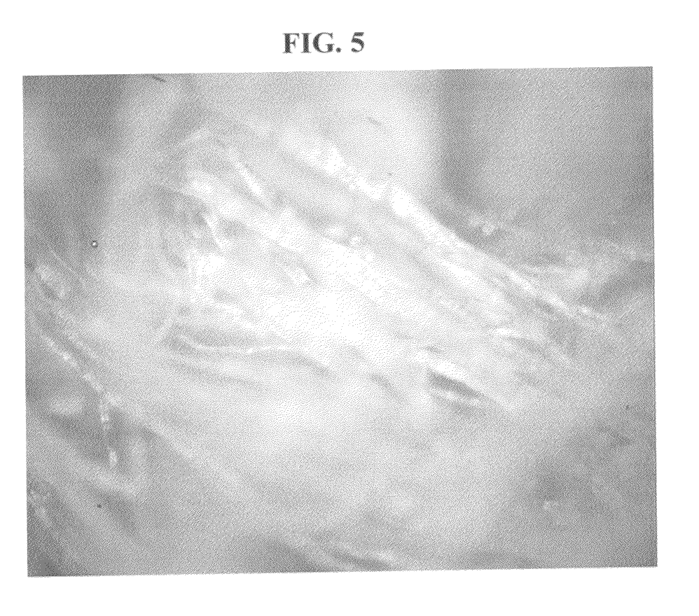

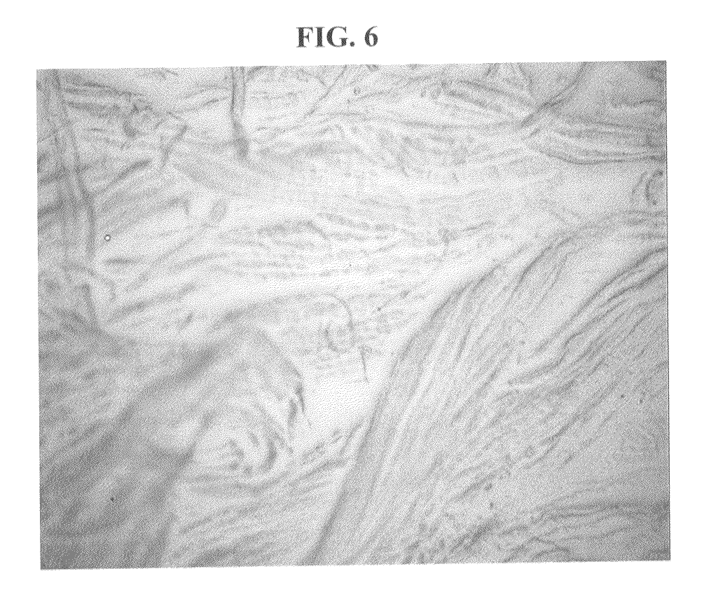

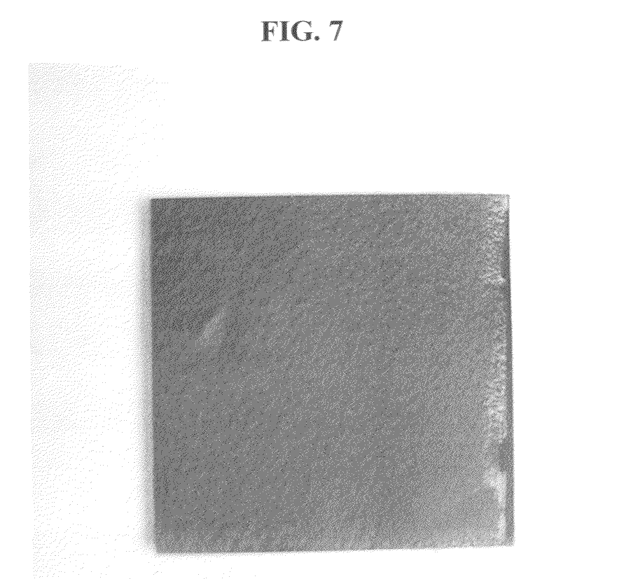

FIG. 1 is a flowchart sequentially illustrating the process of duplicating the nano-pattern texture of the surface of an object according to the present invention. FIG. 2 is a photograph illustrating a large-area master mold, which is manufactured by subjecting a plurality of module master molds, which are imprinted with the surface of natural leather according to an embodiment of the present invention, to edge processing. FIG. 3 is a photograph, twice magnified, of the front surface of natural leather, which is to be molded through nano-imprinting, according to the embodiment of the present invention. FIG. 4 is a photograph, twice magnified, of the mold which is nano-imprinted with the front surface of natural leather according to the embodiment of the present invention. FIG. 5 is a photograph, twice magnified, of the back surface of natural leather, which is to be molded through nano-imprinting, according to the embodiment of the present invention. FIG. 6 is a photograph, twice magnified, of the mold which is nano-imprinted with the back surface of natural leather according to the embodiment of the present invention. FIG. 7 is a photograph illustrating a final product having the nano-pattern texture of the surface of the object, according to the embodiment of the present invention, duplicated thereon

The electroforming process (galvanoplastics) is a technique for duplicating the same surface texture as that of the pattern using electroplating, and performs electrodeposition coating of a thin film of metal ions through electroplating, thus forming a model having the same surface as the pattern. The pattern may be non-metallic or metallic. The non-metallic pattern is pretreated with a separation film or the like, after which the surface thereof is coated with graphite powder or copper powder or with a thin film made of gold or silver, in order to impart conductivity thereto. The surface of the metallic pattern is coated with a thin film made of oxide or graphite powder, that is, a separation film, after which the metallic pattern is placed in an electrolytic bath and is then electrodeposited with a metal component under the flow of current. The metal electrodeposited on the surface of the pattern is removed, thereby obtaining a negative mold having a reversed form. Examples of the metal for electrodeposition include copper, nickel, iron, etc. The reversed form may be used as it is, or alternatively, the surface thereof may be repeatedly subjected to separation film treatment and electroforming, thereby duplicating the same product as the pattern.

Generally, plating and electroforming are distinguished from each other depending on the thickness of the plating layer. For example, the plating layer resulting from plating is 0.001 to 0.05 mm in thick, and the plating layer resulting from electroforming is 0.025 to 25 mm in thick.

The electroforming process is characterized in that various physical properties may be obtained through adjustment of the type and hardness of metal depending on the electrolysis conditions, there is little difference between the duplicate and the pattern, surface duplication is realized with high fidelity, almost no limitations are imposed on the size and shape of the duplicate, high-purity metal products can be obtained, both one-off production and mass production are possible, and seamless tubes or hollow products can be manufactured. However, the electroforming process is disadvantageous because a long period of time is required therefor, unnecessary shapes or minor shapes, such as scratches, may also be duplicated, high technical knowledge for manufacture of the product and design of the pattern is needed, it is difficult to obtain a product having a uniform thickness in the presence of severe roughness and curvature, and high expense incurs.

The electroforming process is a technique for coating the surface of metal with another metal using the principle of electrolysis, and is also referred to as an electroplating process. That is, a plating metal is disposed at the negative electrode, and an electrodepositing metal is disposed at the positive electrode, after which the plating metal is placed in the electrolytic solution containing metal ions to be electrodeposited, and is then electrolyzed under the flow of current, thereby electrodepositing the metal ions on the metal surface.

As a technique corresponding thereto, electroless plating, chemical plating, and self-catalytic plating are exemplary. In the electroless plating, a reducing agent such as formaldehyde or hydrazine supplies electrons for reducing metal ions into metal molecules in an aqueous solution. This reaction occurs on the surface of the catalyst, and the plating agent includes copper, nickel-phosphorus alloys, and nickel-boron alloys. The reducing agent brings about the reduction of another material as it itself is oxidized, and examples thereof include hydrogen, carbon, metal sodium, and sulfite. The electroless plating makes the plating layer denser and the thickness thereof more uniform, compared to electroplating, and also, may be advantageously applied to various patterns including plastic or organic substances, and may thus be used as an alternative in the present invention.

Polydimethylsiloxane (PDMS) is a kind of polymer material suitable for a molding process which facilitates the mass production of fine duplicate products on a nanometer scale of 100 nm or less.

The PDMS, which is a kind of plastic, may be manufactured in the form of a negative mold by mixing a raw material thereof with a curing agent and sintering the mixture in a positive mold having a predetermined shape. When such a PDMS mold is used, a desired nano-pattern may be realized on the surface of another metal using the nano-pattern which is nano-imprinted on the mold, as in the relationship between a stamp and ink. This method is referred to as soft lithography. Instead of the above positive mold, a negative mold may be used.

The nano-imprinting process is a technique for duplicating the nano-pattern surface by placing a stamp having nano-sized surface roughness on a polymer resin-applied substrate and then pressing it thereon, and is classified into hot embossing using heat and UV imprinting to cure the polymer resin on the substrate using UV light. In addition, for mass production, roll imprinting using a roll-shaped stamp is an example thereof. For example, when a photosensitive material such as SU-8 is applied on a silicon wafer and is then patterned using a photomask, a master may be obtained. When PDMS is subjected to casting or injection using the master as a mold and then to sintering, the PDMS mold, functioning as a stamp, may be completed. Soft lithography using the PDMS stamp thus obtained includes microcontact printing, replica molding, microtransfer molding, micromolding using capillaries, etc.

PDMS is advantageous because it is non-toxic and transparent and has very low autofluorescence, and is particularly useful for biological experiments requiring frequent fluorescent measurements. Further, when the surface of the completed PDMS is plasma-treated, surface oxidation occurs to thus realize hydrophilic surface properties, and simultaneously, the above PDMS may be connected with glass or another PDMS material, and therefore it may be widely utilized for the manufacture of microfluidic channels.

The vapor deposition process is a technique for vaporizing an object to thus deposit it on the surface of another object, and includes chemical vapor deposition (CVD) and physical vapor deposition (PVD). CVD serves to form a film on the surface of an object using a chemical reaction. For instance, CVD may be applied as in the formation of a film through the control of a chemical reaction on a semiconductor wafer.

Examples of the CVD include low pressure CVD (LPCVD), plasma enhanced CVD (PECVD), and atmospheric pressure CVD (APCVD), and examples of the PVD include evaporation using metal vapor and sputtering, in which physical impacts are applied to material. In addition, atomic layer deposition (ALD) is useful.

Although it is typically difficult to industrially copy beautiful and soft textures, structures and colors of the skins or surfaces of objects, such as leather, fabric, plants, trees, minerals, or insects, which are present naturally in the natural system or are present artificially through processing and industrial arts, the present invention is intended to repeatedly duplicate a nano-pattern texture similar to that of the surface of the pattern through 2D or 3D scanning, micro- or nano-processing, arrangement, connection, and electroforming.

Among the above objects, any object to be duplicated is selected, for example, leather is selected (S100). The surface of the selected object is washed to remove impurities, and a thin film is formed on the surface of the selected object, which preliminarily processes the surface so that an imprint mold is easily separated therefrom (S110).

As the object to be duplicated, any object having a surface with a micro pattern or specific design, such as artifact or natural product, can be selected and utilized without special limitations. Since certain heat and pressure are applied to the object at the duplication, the surface can be easily deformed by the heat or the pressure, so that the micro pattern or the specific design is likely to be damaged. Therefore, it is desirable to utilize metal such as Au, Pt, Ni, Cu, Co, Pd or the like, semiconductor such as Si, Ge, C, Ga, Sn, In, SiGe, GaAs, AlGaP or the like, natural leather or artificial leather, wood, or synthetic fiber or artificial fiber formed with pattern or design.

The pre-processing method may be varied depending upon the selected object to be duplicated.

Metal

The micro pattern or design formed on the surface of the metal is not deformed under high temperature and high pressure, and is easily separated after the imprinting. When the metal is pre-processed, the surface of the metal is first degreased and washed to remove dust or impurities from the surface, and then is dried by hot air.

Leather

The micro pattern or design formed on the surface of the leather is not easily deformed after the imprinting, but the separation is not easy. In a case of imprinting it without the pre-processing, polymer permeates fine pores of the leather by the heat and the pressure, so that a polymer sheet is not easily separated from leather at the separation. In addition, in a case of forcibly separating the polymer sheet from the leather, the leather will be torn to damage the micro pattern or design to be duplicated, so that it cannot be used a stamp. Therefore, a wanted micro pattern or design cannot be obtained due to the damage of the imprinted polymer sheet, thereby repeating the imprinting process several times. The repeated imprinting process brings about the working time loss and the product loss, so that it may be economically infeasible.

Accordingly, the object is subjected to the pre-processing in order to easily separate the sheet from the leather without damaging the micro pattern or design. The pre-processing is carried out by air-washing the surface of the leather by dry air so as to remove dust or impurities, and evenly spraying a release agent onto the surface of the leather so as to be applied onto the entire surface of the leather.

Fabric

The micro pattern or design formed on the surface of the fabric is not easily deformed after the imprinting, but the separation is not easy. Therefore, the pre-processing is carried out so as to easily separate the sheet from the fabric without damaging the micro pattern or design.

In order to remove dust or impurities from the surface of the fabric, a fabric product is first washed and dried, and then is pressed out wrinkles. If the wrinkles are not pressed out, the wrinkle mark may be duplicated onto the polymer sheet after the imprinting. After the pressing, pure water is sprayed onto the fabric product to restore each strand into its original state. And then, the fabric product is subjected to release treatment for easy separation. In a case where the fabric is not subjected to the release treatment, each strand is embedded into the polymer, so that the separation is not performed. In a case of forcibly separating the polymer sheet from the fabric product, the strands of the fabric will be torn out to damage the micro pattern or design to be duplicated, so that it cannot be used a stamp. In addition, since the strands are left on the imprinted polymer sheet, it is not proper to fabricate a primitive mold after metallization. Therefore, a wanted micro pattern or design cannot be obtained due to the damage of the imprinted polymer sheet, thereby repeating the imprinting process several times. The pre-processing is carried out by evenly spraying a release agent onto the surface of the fabric.

Wood

The micro pattern or design formed on the surface of the fabric is not easily deformed after the imprinting, but the separation is not easy. Therefore, the pre-processing is carried out so as to easily separate the sheet from the fabric without damaging the micro pattern or design. In a case of imprinting it without the pre-processing, the polymer is stuck to the wood by the heat and the pressure, so that the polymer sheet is not easily separated from wood at the separation. In addition, in a case of forcibly separating the polymer sheet from the wood, the wood will be torn to damage the micro pattern or design to be duplicated, so that it cannot be used a stamp. Therefore, a wanted micro pattern or design cannot be obtained due to the damage of the imprinted polymer sheet, thereby repeating the imprinting process several times. The repeated imprinting process brings about the working time loss and the product loss to increase a fabrication cost, so that it may be economically infeasible. Accordingly, the object is subjected to the pre-processing in order to easily separate the sheet from the wood without damaging the micro pattern or design. The pre-processing is carried out by air-washing the surface of the wood by dry air so as to remove dust or impurities, and evenly spraying a release agent onto the surface of the wood so as to be applied onto the entire surface of the wood.

The surface of the object is subjected to nano-imprinting, such as PDMS molding or hot embossing, thus manufacturing a mold (S120).

The nano-imprinting includes one or more selected from among PDMS molding, hot embossing, UV (UltraViolet) imprinting, and roll imprinting, and may be performed using either a casting process or an injection process.

For example, the nano-imprinting may be performed through any one selected from among PDMS molding, hot embossing with a thermoplastic polymer film, UV imprinting, roll imprinting, a combination of UV imprinting and roll imprinting, and a combination of hot embossing and roll imprinting.

Nano-imprinting enables the manufacture of the mold for the duplication of a fine nano-pattern surface, and plays a role in imprinting a nano-structured pattern on the surface of the mold, like the concept of stamping paper. Nano-imprinting materials include thermoplastic, thermosetting, and UV-curable resist material, in addition to PDMS. Although nano-imprinting is similar to the basic principle of polymer molding, it is quite different from a conventional imprinting process because microphysical phenomena, including capillary tube action, electromagnetic power, and attractive force between molecules or atoms, which are negligible or less influential in the conventional technique, must be thoroughly considered when molding a nano-sized structure.

Thus, the nano-imprinting process according to the present invention requires the development of material in consideration of such microphysical phenomena, and requires techniques for managing fine dust having a size from tens of nanometers to hundreds of micrometers, easily occurring under general working conditions, because the mold is manufactured on a nanometer scale. Further, there is an essential need for a vibration insulation system to minimize external vibrations during the work. In this way, the nano-imprinting process according to the present invention is very different from the conventional technique.

The nano-imprint mold, having high precision, is separated, metalized through vapor deposition, and then electroformed, thus obtaining a plurality of small module master molds.

In this instance, the polymer includes acrylonitrile-butadiene-styrene (ABS) plastic, polyacetate, polysulfone, polycarbonate, polystyrene, polyamide, polypropylene, polyvinyl oxide, polyvinyl chloride, polyethylene-terephthalate, and cellulose acetate. The polymer is not specifically limited to a shape or the like, but it is preferable to use a polymer sheet having a thickness of more than 2 mm and less than 5 mm.

In the step, a common nano-imprinting apparatus may be used, and, for example, it may be subjected to the following process.

First, a Teflon sheet is seated on a lower template of the nano-imprinting apparatus, and then an object to be duplicated is put on the Teflon sheet. After the polymer sheet is put on the object to be duplicated, an upper template of the nano-imprinting apparatus is closed, and heat and pressure are applied to the templates to nano-imprint the micro pattern or design formed on the surface of the object to be duplicated on the polymer sheet, thereby fabricating the polymer sheet having the surface imprinted with the wanted pattern.

The nano-imprinting process can be carried out at a pressure of more than 5 atm and less than 20 atm and a temperature of more than 50° C. and less than 150° C.

Meanwhile, the nano-imprinting process may include two steps. That is, in a primary imprinting step, after an initial pressure is set to 2 atm or less so that the object to be duplicated and the polymer sheet are fixed so as not to be moved, a heat plate is heated by a temperature of 50° C. or less. In a secondary imprinting step, the pressure is set to 20 atm or less, the heat plate is heated by a temperature of 150° C. or less within 4 hours.

Next, the pressure is released, and then the heat plate is cooled by cooling water so that its temperature is 25° C. or less. The upper template of the nano-imprinting apparatus is opened, and the object to be duplicated and the duplicate, that is, the imprinted polymer sheet, are taken out and separated.

After the high precisely nano-imprinted sheet is separated, the surface of the nano-imprinted sheet may be subjected to a metallization step. The metallization can electroform a metalized mold to obtain many small module masters.

For example, a metallic layer can be formed on the surface of the nano-imprinted polymer sheet. The duplicated surface of the polymer sheet, which is separated after the nano-imprinting is completed, is etched by using a surface etching agent. Then, after the surface is surface-activated by a surfactant, the completed surface is applied by an Ag solution and a reducing agent to form an Ag surface layer thereon.

Specifically, the etching process is a process of roughening or chemically modifying the surface of the polymer so as to easily adhere the polymer to the Ag surface layer formed on the surface of the polymer sheet. The etching agent may be any one selected from a group consisting of inorganic acid such as hydrogen fluoride (HF), nitric acid (HNO3), phosphoric acid, sulfuric acid, hydrogen peroxide, chromosulfuric acid or the like; organic acid such as acetic acid (CH3COOH), oxalic acid or the like; acid or alkali permanganate solution; and a mixed solution thereof. The etching agent is sprayed onto the complicated surface of the polymer for 5 to 10 seconds. After etching, the duplicated is washed by applying pure water thereon.

The etched polymer is applied by an activator such as colloidal palladium, ionic palladium, silver colloid, partially dissolved sulphide, polysulfide or the like to activate the surface of the polymer sheet, and then is applied by the pure water to clean the surface.

The surface-activated polymer is sequentially applied by the silver solution and the reducing agent to form the silver surface layer on the duplicated surface of the polymer sheet.

In this instance, the silver solution which is made by dissolving silver nitrate of 5˜10 g/L to ultrapure water may be used, but is not specifically limited to its concentration.

The reducing agent includes sodium hypophosphite, dimethylamino borate, hydrazine, hydrazine hydrate, hydroxylamine sulfate, sulfite, and formate. The polymer sheet with the silver surface layer may be cleaned by spraying the pure water thereon, and then be dried.

In some embodiments, in addition to the wet silver curing, chemical vapor deposition (CVD), plasma vapor deposition, atmospheric chemical vapor deposition, and physical vapor deposition may be selectively applied. Before the vapor deposition is applied, if necessary, the nano-separation film process can be selectively applied, as described above. The metallization of the mold may use a spraying method, in addition to the vapor deposition method.

The metalized mold resulting from vapor deposition is subjected to electroforming, thus obtaining a plurality of small module master molds (S130). Instead of fabricating the module master molds, one completed primitive mold can be fabricated, and the primitive mold may be formed in a flat shape or cylindrical shape. In particular, the cylindrical mold can be used a rolling roller in the rolling process to produce continuous pattern duplicates, which will be described hereinafter in detail.

The nano-pattern of the surface of the object to be duplicated is subjected to 2D or 3D scanning, thus designing a predetermined standard pattern and preparing for processing. Such processing may be performed through etching.

The edges of the module master molds thus manufactured are uniformly trimmed, after which predetermined widths of the edges thereof are subjected to 2D or 3D micro- or nano-processing to impart the designed standard pattern, and the module master molds thus processed are arranged, precisely connected through adhesion or welding, and then electroformed, thereby manufacturing a metal unit master mold (S140). The process of manufacturing the unit master mold is carried out, as described above, in the case where the primitive mold manufactured from the metalized mold is the small module master mold, but may be omitted in the case of manufacturing the cylindrical primitive mold or a general unitary flat mold.

The master mold thus manufactured is in a positive form. In the case where a negative master mold is required, it may be ensured by repeating the electroforming. The 2D or 3D processing is micro- or nano-technology for naturally connecting the edges of respective module molds having the duplicated nano-imprinted pattern.

Next, using the unit master mold, metal electroforming or plastic extrusion or injection is performed, thus producing a duplicate having the nano-pattern texture of the surface or skin of the selected object (S150). The produced duplicate is further subjected to vapor deposition or painting for coloring treatment and coating for physical or chemical protection, and is thereby completed (S160).

According to the embodiment of the present invention, in the production of the duplicate having the same nano-pattern texture as the surface of the object, when an extrusion process is performed through casting, the unit master mold having the nano-pattern surface roughness is pressed on plastic, thus producing the duplicate having the nano-pattern texture, after which the mold is separated. The production method according to the present invention is characterized in that it requires techniques for precise arrangement, vibration insulation to minimize external vibration, equilibrium between the nano mold and the plastic and defoaming, lathe having micro- or nano-precision, and the application of uniform pressure over a large area, and is thus evidently different from the conventional technique. The nano-pattern texture of the surface of the selected object may also be duplicated on metal through electroforming.

Referring to FIG. 2, there is illustrated a large-area mold completed by subjecting the plurality of small module master molds, in which the front and back surfaces of natural leather, selected according to the embodiment of the present invention, are nano-imprinted, to 2D or 3D processing and precise edge processing to impart the standard pattern, and connecting the module master molds.

That is, the front and back surfaces of natural leather, having a small size, are imprinted through hot embossing using a thermoplastic polymer film, and are then subjected to 2D or 3D edge processing to impart the standard pattern set through surface scanning, thereby completing the mold.

FIG. 3 is a photograph, magnified 2.times., of the front surface of natural leather selected for nano-imprinting of the surface texture according to the embodiment of the present invention, FIG. 4 is a photograph, magnified 2.times., of the mold imprinted with the natural leather of FIG. 3, FIG. 5 is a photograph, magnified 2.times., of the back surface of natural leather selected for imprinting according to the embodiment of the present invention, FIG. 6 is a photograph, magnified 2.times., of the mold imprinted with the natural leather of FIG. 5, and FIG. 7 is a photograph of the state of a final product having the nano-pattern texture of the surface of the object selected according to the embodiment of the present invention, duplicated thereon.

The nano-pattern texture of the surface of the selected object according to the present invention may be duplicated on either metal or plastic. Hence, the technique of the present invention as above is advantageous because the nano-pattern texture of the skin or surface of the selected object is nano-imprinted, thus manufacturing the mold, which is then repeatedly electroformed, thus duplicating it on metal or plastic.

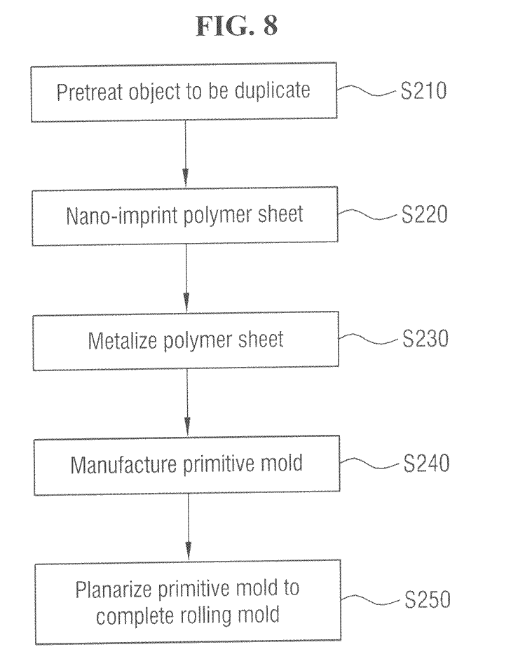

Now, a pattern duplicating method according to another embodiment of the present invention will now described with reference to FIGS. 8 to 11.

The pattern duplicating method according to another embodiment of the present invention includes a step of pre-treating an object to be duplicated (S210), a step of nano-imprinting the pre-treated object on a polymer sheet (S220), a step of metalizing the surface of the nano-imprinted polymer sheet (S230), and a step of mounting the polymer sheet having the metalized surface to a cylindrical jig and plating the polymer sheet to manufacture a plated primitive mold (S240). The method can further include a step of planarizing the inner periphery surface of the plated primitive mold to manufacture the rolling mold (S250).

According to another embodiment of the present invention, the steps until the step (S230) of metalizing the sheet duplicated with the pattern by the nano-imprinting are identical to the above embodiment, but, instead of manufacturing the small module master molds, the cylindrical primitive mold can be manufactured by plating it with the sheet having the metalized surface, and the rolling process can be carried out by using it to produce the consecutive pattern duplicate.

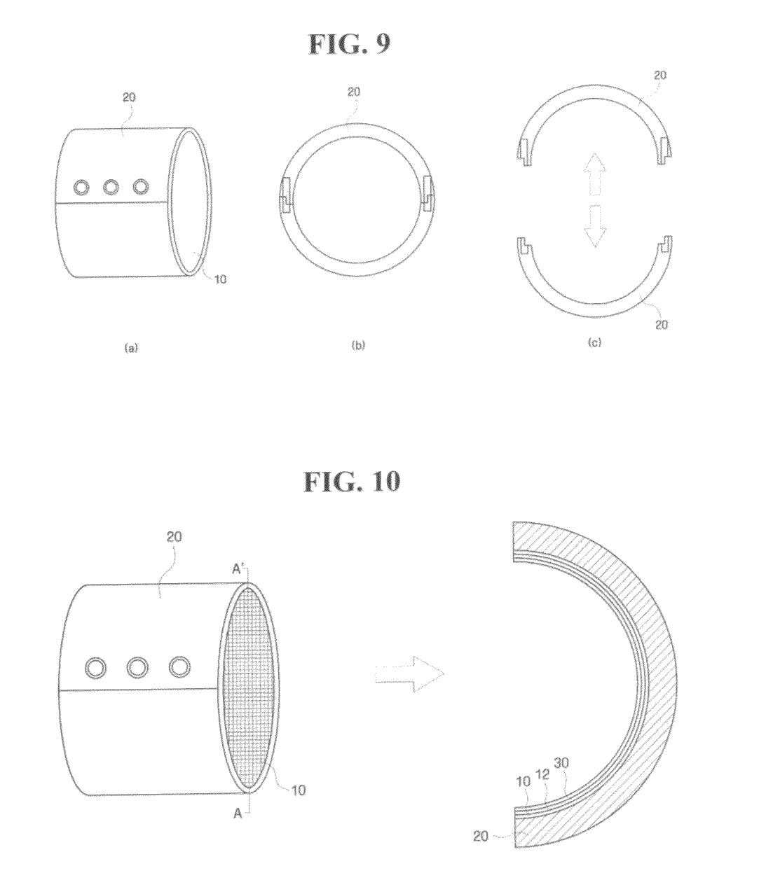

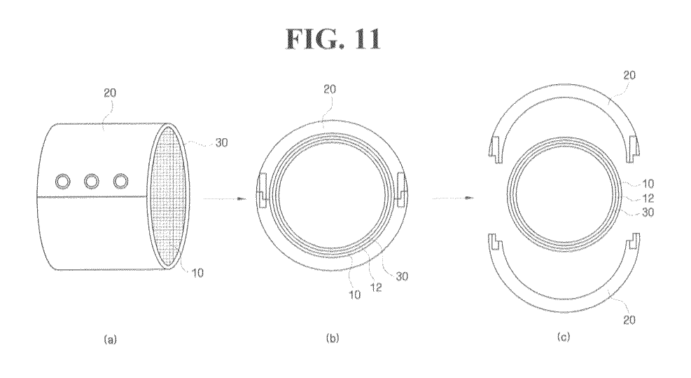

Specifically, the embodiment can produce the pattern duplicate according to the procedure shown in FIG. 8, and can manufacture a primitive mold 100 and a rolling mold 200 by use of a cylindrical jig 20 shown in FIGS. 9 to 11. FIG. 8 is a flowchart illustrating a pattern duplicating process according to the embodiment. FIG. 9 is a view illustrating the cylindrical jig 20 used in the step of manufacturing the primitive mold 100 in the pattern duplicating process according to the embodiment. FIG. 10 is a view illustrating a polymer sheet 10 attached to the cylindrical jig 20 used in the step (S140) of manufacturing the primitive mold according to the embodiment. FIG. 11 is a view illustrating a step of separating the manufactured rolling mold from the cylindrical jig in the pattern duplicating method according to the embodiment.

First, by the metallization step, the sheet 10 formed with a silver surface layer 12 is attached to the prepared cylindrical jig 20. The cylindrical jig 20 may be coupled to the imprinted flexible sheet 10, for example, the polymer sheet 10. In this instance, the silver surface layer 12 of the imprinted sheet 10 may be connected to the cylindrical jig 20 by a copper tape in order to easily apply an electric current thereto.

In addition, the cylindrical jig 20 is not specifically limited to its shape if it is used in the manufacture of common cylindrical molds, and may be appropriately selected and used in view of the area of the polymer sheet 10.

Preferably, the cylindrical jig 20 having an outer diameter of 170 millimeters, an inner diameter of 130 millimeters, and a height of 105 millimeters may be used, but may be varied depending upon a dimension of the wanted rolling mold. In addition, the cylindrical jig 20 preferably has a thickness of 20 millimeters, but is not limited thereto. Furthermore, the cylindrical jig 20 which is able to be divided in a radial direction may be used, and may include fastening means 22 at left and right sides of the cylindrical jig 20 which are able to be coupled to each other along a separation line. Accordingly, the present invention is configured to attach the polymer sheet 10 by coupling the cylindrical jig 20 with bolts at left and right sides thereof, and form a plated layer 30 and then easily separate the plated layer 30 and the polymer sheet 10 by separating them in the radial direction after the inner periphery is planarized.

With reference to FIG. 10, since it is not necessary to plate the polymer sheet 10 except for the portion on which the silver surface layer 12 is formed, the copper tape, and the outside of the cylindrical jig 20 are masked by a masking tape. The cylindrical jig 20 attached with the polymer sheet 10 is degreased by a metal degreasing agent such as alkaline salt including sodium hydroxide, sodium carbonate, sodium silicate, or sodium phosphate, and then is washed by the pure water.

Then, the cylindrical jig 20 attached with the polymer sheet 12 having the silver surface layer 12 is put in an electroplating cell to perform electroplating. The electroplating is performed until the metallic plated layer 30 has a thickness of more than 500 μm and less than 1000 μm which can be used as a primitive mold.

If the electroplating is completed, after the plated cylindrical jig 20 is put out from the plating cell, it is washed by the pure water and then is dried to manufacture a primitive mold 100 formed with the metallic plated layer 30 formed on the inner periphery. In this instance, the plating bath can be properly selected depending upon a kind of plating metal to be formed, and, specifically, acid copper bath or nickel bath can be used.

After that, the inner periphery of the primitive mold 100 is subjected to a planarization process such that it may be used as a rolling mold 200 by inserting a rolling dummy roller into the primitive mold 100.

First, the cylindrical jig 20 formed with the plated layer 30 is mounted to the lathe. The mounting of the cylindrical jig 20 is carried out by using the fourth chuck of the lathe, and a bite of 0.2 to 1.0R is mounted to a tool rest having a bite holder.

The inner periphery of the primitive mold 100 is machined by rotation at a constant low rotational speed of 60 to 200 RPM. In this instance, the moving speed of the bit machining the plated layer 30 of the inner periphery at a constant thickness is set to 0.05 to 0.5 mm/min for one lead. The machining is performed until the thickness of the inner periphery is 200 to 500 μm. If the machining of the inner periphery is performed at fast speed, a frictional heat is generated to lead to deformation of the polymer sheet 10, which cannot perform the planarization machining. If the moving speed is fast, a machining recess is formed on the plated layer 30, so that the machining recess can be duplicated together with the wanted pattern at the rolling. Therefore, the machining should be performed under the above conditions.

If the machining is completed, the cylindrical jig 20 with the polymer sheet 10 is removed from the lathe. After that, the polymer sheet 10 and the plated layer 30 with the machined inner periphery are separated from the cylindrical jig 20 by unfastening the bolts 22 from the cylindrical jig 20. Then, the polymer sheet 10 formed with the silver surface layer 12 is separated from the plated layer 30 to manufacture the rolling mold 200.

That is, according to the embodiment, as shown in FIG. 11a, after the polymer sheet 10 is coupled to the cylindrical jig 20, the inner periphery is subjected to the plating and machining, as shown in FIG. 11b, and then the cylindrical jig 20 is separated, as shown in FIG. 11c, thereby manufacturing the rolling mold 200.

It can manufacture the rolling mold 200, which can duplicate the same micro pattern or specific design as the original, by the above method at high degree of completion. The completed rolling mold 200 can be manufactured to have a width of 10 centimeters to 120 centimeters and a circumferential length of 10 centimeters to 240 centimeters, and it surface is formed with a micro pattern of the object to be duplicated. It is preferable that the width and circumferential length of the rolling mold 200 is equal to the size of the metal member rolled by the rolling mold 200. Specifically, it is preferable that the width of the rolling mold 200 is equal to the width of the metal sheet to be rolled and the circumferential length of the rolling mold 200 is equal to the length of the metal member.

The completed rolling mold 200 can be used in various industrial fields such as diverse electronic device industrial process including semiconductors, and displays to stably and easily form the micro patterns. Specifically, it can manufacture an outer case of cellular phones having a width of 10 centimeters to finishing materials for building having a width of 120 centimeters or more.

Specifically, metal sheets or plastic plates are rolled by using the rolling mold 200 to form the micro pattern or nano pattern on the surface of the metal sheets or plastic plates.

The plastic plates may consist of a substrate and a resin layer which is formed by a resin composite, which may contain at least one selected from a nitrocellulose, a thermoset, and a thermoplastic. The substrate can be made of a polyethyleneterephthalate(PET). The thermoset can be made of a melamine resin, and the thermoplastic can be made of an acrylic resin.

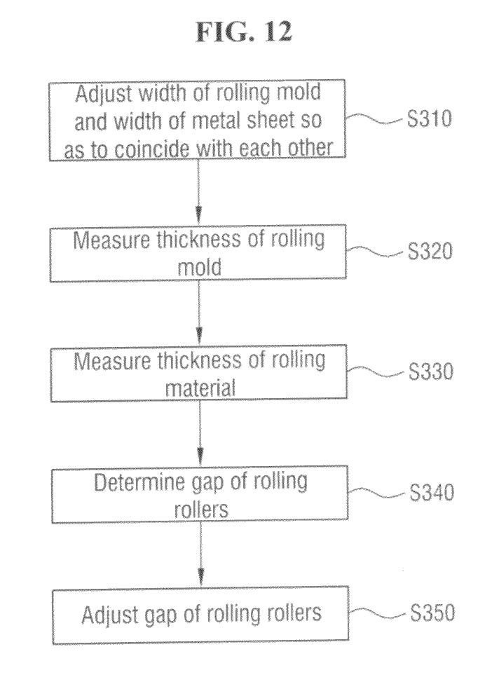

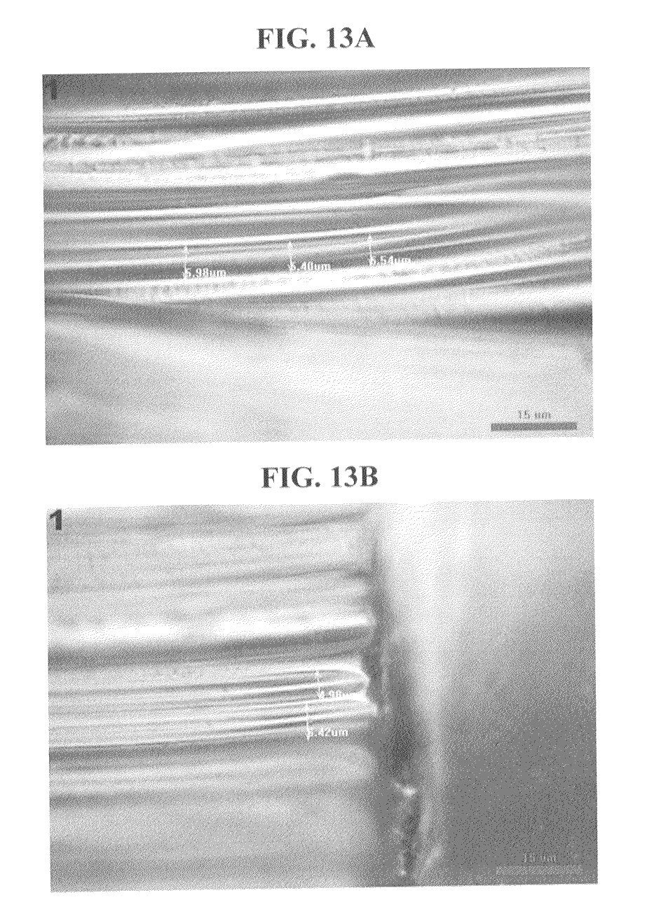

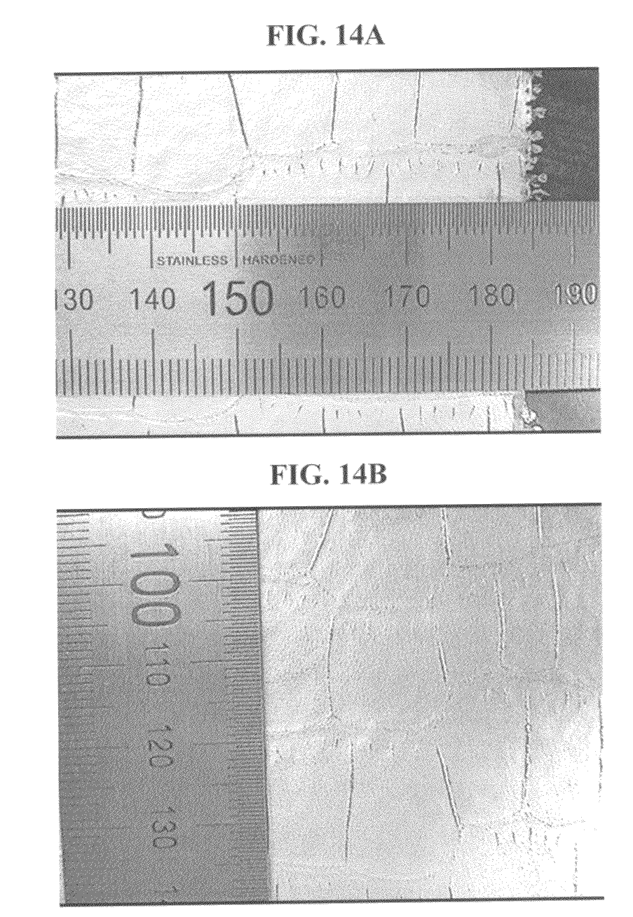

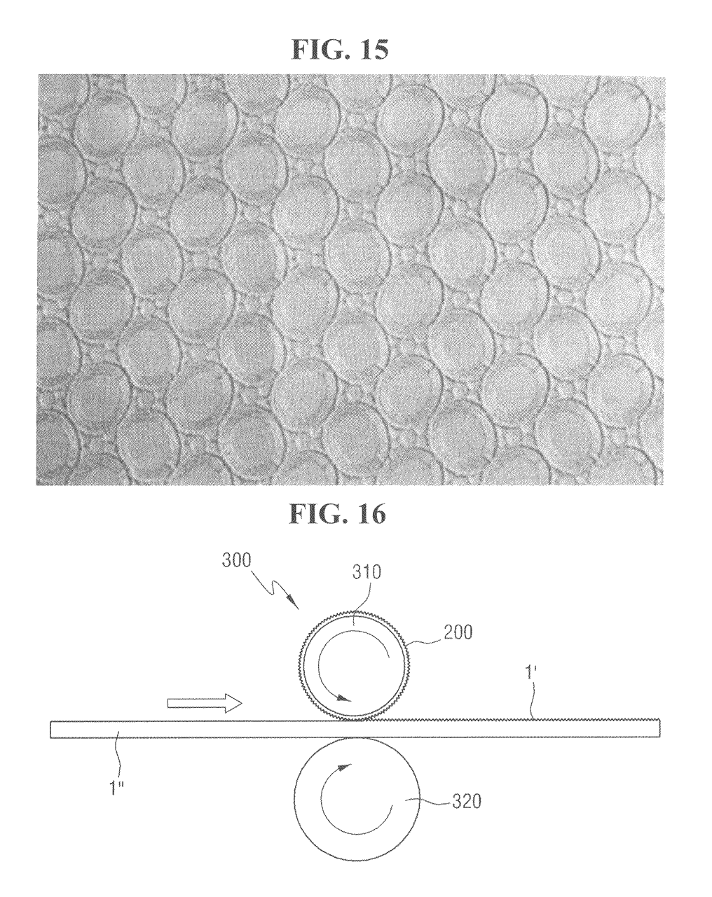

Then, the process of setting rolling conditions of the pattern duplicating method according to the embodiment will be described with reference to FIGS. 12 to 15. FIG. 12 is a flowchart illustrating a step of setting rolling conditions in the process of forming the micro pattern on the surface of the metal sheet according to the embodiment. FIGS. 13A and 13B are photomicrographs of the surface of a metal sheet duplicated with micro pattern of silk. FIGS. 14A and 14B are photographs enlarging the surface of the metal sheet duplicated with micro pattern of leather. FIG. 15 is another photograph enlarging the surface of the metal sheet duplicated with a micro pattern of an object to be duplicated.

Now, the process of rolling the metal sheet by using the rolling mold 200 to form the pattern duplicate will be described, but the present invention is limited thereto.

With reference to FIG. 12, the step of setting the rolling conditions according to the embodiment of the present invention includes a step of adjusting the width of the rolling mold to coincide with the width of the metal sheet (S310), steps of measuring the thickness of the rolling mold and the rolling material (S320 and S330), a step of determining a gap of the rolling rollers based on the measured values (S340), and a step of adjusting the gap of the rolling rollers of the roller machine (S350). More specifically, by measuring the thickness of the metal sheet, the gap of the rolling rollers can be set to the pitch of the micro pattern formed on the metal sheet as 5 μm to 20 mm, and the depth as 1 μm to 330 μm.

In this instance, the step (S310) of adjusting the width of the rolling mold to coincide with the width of the metal sheet prevents damage of the rolling mold 200 when the surface of the metal sheet is rolled by using the rolling mold 200, forms the micro pattern and the 3D design on the surface of the metal sheet at a correct position, and minimizes a residual stress on the metal sheet to minimize the bending phenomenon in which the metal sheet is bent due to the residual stress after the rolling. If the rolling mold 200 is larger than the metal sheet which is an object to be duplicated, the edge of the rolling mold 200 which does not come into contact with the metal sheet is not pressed, so that this portion is distinguished from the pressed portion. If so, the stress of the rolling mold is concentrated on the edge due to the continuous rolling, so that the rolling mold 200 may be ruptured by the residual stress. And, if the metal sheet is larger than the rolling mold 200, the stress generated at the rolling is concentrated on the edge of the metal plate to largely bend the metal sheet. If the metal sheet is largely bent, it is not likely to be smoothly planarized in the planarization process which is pretreatment. When the planarization process is performed by force, it may be damaged depending upon the material.

The steps (S320 and S330) of measuring the thickness of the rolling mold 200 and the rolling material and the step (S340) of determining the gap of the rolling rollers are important steps in the embodiment of the present invention. If the gap is set in the state in which the thickness of the rolling mold 200 and the metal material is not accurately measured, there may be a problem in the quality of the micro pattern and the 3D design formed after the rolling. If the gap of the rolling rollers is set larger than a desired gap, the surface texture of the micro pattern and the 3D design formed after the rolling is decreased, and thus the gloss effect is decreased. If the gap of the rolling rollers is set to be small, the rolling mold 200 and the metal sheet are excessively pressed at the rolling, so that the lifetime of the rolling mold 200 is decreased, or the metal sheet is excessively extended. Therefore, the position of the formed micro pattern and 3D design is different from the wanted position, thereby lowering the quality of the product.

The step (S350) of adjusting the gap of the rolling rollers of the roller machine is to set the gap of the rolling rollers as the width determined by measuring the thickness of the rolling mold 200 and the metal sheet. It is preferable to set the gap of the rolling rollers so as to apply a proper pressure so that the pitch of the micro pattern is 5 μm to 20 mm, and the depth is 1 μm to 330 μm.

The pitch of the micro pattern of the completed metal sheet is shown in FIG. 13A to FIG. 148. It will be seen from FIGS. 13A and 138 that the pitch of the micro pattern is formed at about 5 μm. It will be seen from FIGS. 14A and 14B that the pitch of the micro pattern is formed at about 20 mm. That is, the pitch of the micro pattern formed on the surface of the metal sheet is varied depending upon the kind of the object to be duplicated, and is not strictly limited to 5 μm to 20 mm.

Meanwhile, the depth of the micro pattern of the completed metal sheet is calculated by a difference between the height at the maximum protruding position and the height at the minimum position, as shown in FIG. 15. In the pattern shown in FIG. 15, the depth of the micro pattern of the metallic surface is shown as 330 μm. The above numerical values are values actually measured, and, as described above, since a value of about 330 μm can be obtained depending upon the kind of the object to be duplicated, it is not strictly limited to the range of 330 μm or less.

The rolling process according to the embodiments of the present invention is to form the micro pattern in the state in which the thickness change of the metal sheet is minimized, unlike the purpose and configuration of the common rolling of extruding the metal sheet, it is necessary to set the gap of the rolling rollers so as to apply a proper pressure. Finally, in order to set the pitch of the micro pattern formed on the metal sheet as 5 μm to 20 mm and the depth as 1 μm to 330 μm, the rolling can be performed at a pressure lower than that of the common rolling process in such a way that the rolling pressure is set as 1 ton to 10 tons. If the pressure of 1 ton or less is applied, the effect of forming the micro pattern on the surface of the metal sheet is decreased, so that the formation of the pattern is not easily achieved. If the pressure of 10 tons or more, the micro pattern may be damaged.

Taking all the above matters into consideration, it is preferable to set the gap of the rolling rollers as a value in the range of 10% to 50% of the whole thickness of the rolling mold 200 and the metal sheet. If the gap of the rolling rollers is set as more than 50%, the surface texture of the micro pattern and the 3D design formed after the rolling is decreased, and thus the gloss effect is decreased. If the gap of the rolling rollers is set as less than 10%, the rolling mold and the metal sheet are excessively pressed at the rolling, so that the lifetime of the rolling mold is decreased, or the metal sheet is excessively extended. Therefore, the position of the formed micro pattern and 3D design is different from the wanted position, thereby lowering the quality of the product.

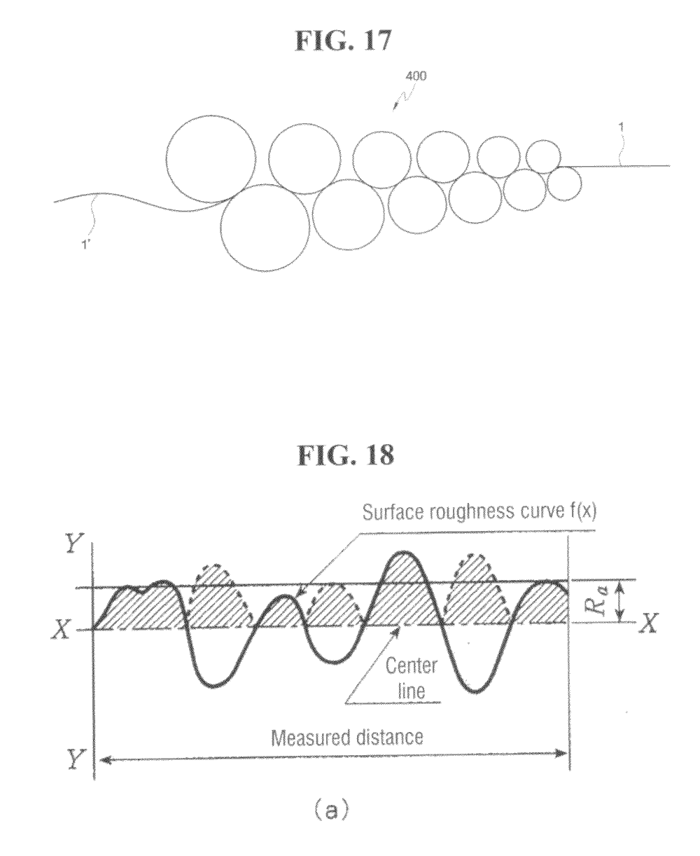

Next, the rolling process and the planarization process according to another embodiment of the present invention will be described with reference to FIGS. 16 and 17. FIG. 16 is a view schematically illustrating a rolling step according to another embodiment of the present invention. FIG. 17 is a view schematically illustrating a step of planarizing the metal sheet 1′ rolled according to another embodiment of the present invention.

With reference to FIG. 16, the step of rolling the metal sheet 1″ is performed by the rolling roller 300 including an upper rolling roller 310, on which the rolling mold 200 is positioned, and a lower dummy roller 320 supporting the metal sheet. After the metal sheet 1″ is positioned to coincide with the thickness of the rolling mold 200, the rolling roller 300 is driven to manufacture the metal sheet 1′ having the surface formed with the micro pattern and the 3D design by the rolling mold 200. In this instance, the metal sheet 1″ should be positioned to coincide with the width of the rolling mold 200. If not, the rolling mold 200 may be damaged or the quality of the product may be deteriorated. At the rolling in the state in which the metal sheet 1″ does not coincide with the width of the rolling mold 200, the micro pattern and the 3D design are not formed on a portion f the metal sheet, thereby losing the value of the product. Since the portion not formed with the micro pattern and the 3D design is increased due to continuously unbalanced rolling force, the metal sheet may be absolutely deviated from the rolling mold 200 in the prior art. In addition, since a portion of the rolling mold 200 is not applied by the rolling force, a line which can be distinguished from the portion applied by the rolling force is generated on the rolling mold 200, so that the function of the rolling mold 200 is lost.

The thickness of the used metal sheet may be varied depending upon the material, and various metal sheets having the thickness of 10 μm to 5 mm may be used. The metal sheet 1″ is applied by the constant pressure by the rolling mold 200 to duplicate the micro pattern of the rolling mold 200. As described above, it is preferable that the rolling pressure applied at this instance has a value of 1 ton to 10 tons, and the gap between the rolling rollers is set to a value of 10% to 50% of the whole thickness of the rolling mold 200 and the metal sheet.

In general, in the case of rolling process of extruding the metal sheet, the thickness variation of the metal sheet after rolling is performed is 40% or more. That is, a common rolling process provides the metal sheet with improved productivity by thinly machining the metal sheet and simultaneously changing the refining of the metal sheet, but in the rolling process of forming the micro pattern according to the embodiments of the present invention, the thickness variation between the metal sheet after the rolling is performed and the metal sheet 1″ before the rolling has performed is minute. Preferably, the thickness variation of the metal sheet before and after the rolling is shown within 10%, as Table 1 below.

TABLE 1

| | | | Kind of aluminum | | | | | | | |
|---|---|---|---|---|---|---|---|---|---|---|
| | | | 1050 (H12) | | 3003 (H12) | | 3003 (H12) | | 5050 (H0) | |
| Thickness before rolling (μm) | | | 500 | Variation rate (%) | 400 | Variation rate (%) | 700 | Variation rate (%) | 800 | Variation rate (%) |
| Thickness | Rolling | 50 | 470 | 6.0 | 390 | 2.5 | 670 | 4.3 | 770 | 3.8 |
| after | gap | 40 | 470 | 6.0 | 390 | 2.5 | 660 | 5.7 | 760 | 5.0 |
| rolling | (%) | 30 | 460 | 8.0 | 390 | 2.5 | 660 | 5.7 | 760 | 5.0 |
| (μm) | | 20 | 460 | 8.0 | 390 | 2.5 | 650 | 7.1 | 750 | 6.3 |
| | | 10 | 450 | 10.0 | 390 | 2.5 | 650 | 7.1 | 750 | 6.3 |

That is, with reference to Table 1, the thickness variations before and after the rolling according to the setting of the rolling gap depending upon the kind of aluminum are shown. As described above, the thickness variations of the metal sheet before and after the rolling are shown with 10%, unlike the common rolling process.

With reference to FIG. 17, the rolled metal sheet 1′ can be bent in a certain direction by the step of rolling the metal sheet according another embodiment of the present invention. Accordingly, the metal sheet 1 having the wanted flatness can be obtained by the step of planarizing the metal sheet 1′. According to the method of planarizing the rolled material, as shown in FIG. 17, a plurality of rolling rolls 400 for planarization having different diameter and rotational speed are arranged up and down to be offset in a zigzag pattern, and the metal sheet 1′ formed with the micro pattern and the 3D design is passed and planarized, so that the pretreatment can be easily performed.

Now, preferred experiment samples will be described in order to easily understand the present invention. The embodiments below are only illustrative of the present invention, but the scope of the present invention is not limited to the experiment examples below.

### Experiment Example 1

### Metal

Step of Pretreating Object to be Duplicated (S210)

A copper (Cu) sheet having a surface with a micro pattern was selected as an object to be duplicated, and then was degreased at a temperature of 42° C. for 10 minutes. After degreasing, the copper sheet was washed by spraying pure water of 22° C. three times each for 30 seconds, and then was dried by hot air of 65° C. for 5 minutes.

Step of Nano-Imprinting the Pretreated Object to Polymer Sheet (S220)

After a Teflon sheet was seated on a lower template of the nano-imprinting apparatus, the object to be duplicated was put on the Teflon sheet, and then a polymer sheet having a thickness of 5 millimeters was put on the object to be duplicated. After the polymer sheet was seated, an upper template of the nano-imprinting apparatus was closed, and the initial pressure was set to 1 atm so that the object to be duplicated and the polymer sheet were fixed so as not to be moved. A heat plate was primarily heated by a temperature of 50° C. or less, and then after the pressure was set to 20 atm or less, the heat plate was secondarily applied by the pressure and heat for 4 hours. And then, it was cooled until the temperature was 25° C. or less, the upper template of the nano-imprinting apparatus was opened to take out and separate the object to be duplicated and the duplicate.

Step of Metalizing Surface of Nano-Imprinted Polymer Sheet (S230)

After the duplicated surface of the separated polymer sheet was sprayed by acetate acid for 10 seconds, pure water was sprayed onto the surface for 10 seconds to wash it. Then, the surface was activated by spraying colloid palladium onto the surface for 10 seconds, and then the pure water was sprayed onto the surface for 10 second to wash the surface.

The polymer with an activated surface was sprayed by a silver solution and a reducing agent for 10 seconds to form an Ag surface layer on the duplicated surface. The pure water was sprayed onto the surface for 10 seconds to wash the surface, and then the polymer sheet formed with the Ag surface layer was dried at a temperature of 60° C. for 15 minutes.

Step of Plating Polymer Sheet Having Metalized Surface to Manufacture Primitive Mold (S240)

The polymer sheet formed with the silver surface layer was attached to a cylindrical jig capable of easily applying an electric current. The silver surface layer of the polymer sheet was connected to the cylindrical jig by a copper tape in order to easily apply an electric current thereto. In order to form a metallic layer, the portion which does not need for plating was masked by a masking tape. After masking, the cylindrical jig attached by the polymer sheet was degreased by a metallic degreasing agent, and then was washed by the pure water. In this instance, the cylindrical jig had an outer diameter of 170 millimeters, an inner diameter of 130 millimeters, a thickness of 20 millimeters and a height of 105 millimeters, as shown in FIG. 1. The cylindrical jig was which was able to be coupled and decoupled in a radial direction by bolts at left and right sides of the cylindrical jig was used, so that the plated layer was formed and the inner periphery was planarized, the cylindrical jig was decoupled in the radial direction so easily separate the plated layer and the polymer sheet.

Then, the cylindrical jig attached with the polymer sheet having the silver surface layer was put in an electroplating cell, and then a power source was turned on. The electroplating was performed until the metallic plated layer had a thickness of 500 μm.

The plated cylindrical jig was put out from the plating cell, and was dried to manufacture a primitive mold including the cylindrical jig having the inner periphery with the plated layer.

Step of Planarizing Inner Periphery of Primitive Mold (S250)

The cylindrical jig having the inner periphery plated with the primitive mold was mounted to a lathe. The mounting of the cylindrical jig was carried out by using the fourth chuck of the lathe, and a bite of 0.8R was mounted to a tool rest having a bite holder. The inner periphery was machined by rotation at a constant rotational speed of 120 RPM. In this instance, the moving speed of the bit machining the plated layer of the inner periphery at a constant thickness was set to 0.1 mm/min for one lead. The machining was performed until the thickness of the inner periphery was 300 μm.

After the machining was completed, the cylindrical jig was removed from the lathe. The polymer sheet and the plated layer with machined inner periphery were separated from the cylindrical jig, and then the plated layer was removed from the polymer sheet to obtain an electroforming mold having the plated layer with a constant thickness. The electroforming mold was thermally shrunk to a dummy rolling roller to manufacture the rolling mold.

### Experiment Example 2

### Leather

Step of Pretreating Object to be Duplicated (S210)

Leather having a pattern was selected as an object to be duplicated, and then was washed by dried air so as to eliminate dust or impurities from the surface of the leather. After washing, the surface of the leather was evenly sprayed by a silicon releasing agent to apply it onto the whole surface of the leather. After that, it was left in the air for 5 minutes so that the silicon releasing agent was permeated into the surface of the leather. After being left for 5 minutes, the silicon releasing agent was again evenly applied onto the whole surface of the leather. The pretreating was completed by leaving it in the air for 5 minutes so that the silicon releasing agent was permeated into the leather.

Step of Nano-Imprinting the Pretreated Object to Polymer Sheet (S220)

After a Teflon sheet was seated on a lower template of the nano-imprinting apparatus, the object to be duplicated was put on the Teflon sheet, and then a polymer sheet having a thickness of 5 millimeters was put on the object to be duplicated. After the polymer sheet was seated, an upper template of the nano-imprinting apparatus was closed, and the initial pressure was set to 1 atm so that the object to be duplicated and the polymer sheet were fixed so as not to be moved. A heat plate was primarily heated by a temperature of 50° C. or less, and then after the pressure was set to 20 atm or less, the heat plate was secondarily applied by the pressure and heat for 4 hours. And then, it was cooled until the temperature was 25° C. or less, the upper template of the nano-imprinting apparatus was opened to take out and separate the object to be duplicated and the duplicate. Depending upon whether the object to be duplicated was pretreated or not, it was determined whether or not the polymer sheet with good pattern duplication could be obtained in the nano-imprinting process.

Step of Metalizing Surface of Nano-Imprinted Polymer Sheet (S230)

After the duplicated surface of the separated polymer sheet was sprayed by acetate acid for 10 seconds, pure water was sprayed onto the surface for 10 seconds to wash it. Then, the surface was activated by spraying colloid palladium onto the surface for 10 seconds, and then the pure water was sprayed onto the surface for 10 second to wash the surface.

The polymer with an activated surface was sprayed by a silver solution and a reducing agent for 10 seconds to form an Ag surface layer on the duplicated surface. The pure water was sprayed onto the surface for 10 seconds to wash the surface, and then the polymer sheet formed with the Ag surface layer was dried at a temperature of 60° C. for 15 minutes.

Step of Plating Polymer Sheet Having Metalized Surface to Manufacture Primitive Mold (S240)

The polymer sheet formed with the silver surface layer was attached to a cylindrical jig capable of easily applying an electric current. The silver surface layer of the polymer sheet was connected to the cylindrical jig by a copper tape in order to easily apply an electric current thereto. In order to form a metallic layer, the portion which does not need for plating was masked by a masking tape. After masking, the cylindrical jig attached by the polymer sheet was degreased by a metallic degreasing agent, and then was washed by the pure water. In this instance, the cylindrical jig had an outer diameter of 170 millimeters, an inner diameter of 130 millimeters, a thickness of 20 millimeters and a height of 105 millimeters, as shown in FIG. 1. The cylindrical jig was which was able to be coupled and decoupled in a radial direction by bolts at left and right sides of the cylindrical jig was used, so that the plated layer was formed and the inner periphery was planarized, the cylindrical jig was decoupled in the radial direction so easily separate the plated layer and the polymer sheet.

Then, the cylindrical jig attached with the polymer sheet having the silver surface layer was put in an electroplating cell, and then a power source was turned on. The electroplating was performed until the metallic plated layer had a thickness of 500 μm.

The plated cylindrical jig was put out from the plating cell, and was dried to manufacture a primitive mold including the cylindrical jig having the inner periphery with the plated layer.

Step of Planarizing Inner Periphery of Primitive Mold (S250)

The cylindrical jig having the inner periphery plated with the primitive mold was mounted to a lathe. The mounting of the cylindrical jig was carried out by using the fourth chuck of the lathe, and a bite of 0.8R was mounted to a tool rest having a bite holder. The inner periphery was machined by rotation at a constant rotational speed of 120 RPM. In this instance, the moving speed of the bit machining the plated layer of the inner periphery at a constant thickness was set to 0.1 mm/min for one lead. The machining was performed until the thickness of the inner periphery was 300 μm.

After the machining was completed, the cylindrical jig was removed from the lathe. The polymer sheet and the plated layer with machined inner periphery were separated from the cylindrical jig, and then the plated layer was removed from the polymer sheet to obtain an electroforming mold having the plated layer with a constant thickness. The electroforming mold was thermally shrunk to a dummy rolling roller to manufacture the rolling mold.

### Experiment Example 3

### Fabric

Step of Pretreating Object to be Duplicated (S210)

Fabric (silk) having a specific pattern or design was selected as an object to be duplicated, and then was washed and dried so as to eliminate dust or impurities from the surface of the fabric. After the fabric product was dried, it was pressed out wrinkles. If the wrinkles were not pressed out, the wrinkle mark might be duplicated onto the polymer sheet after the imprinting.

After the pressing, each strand of the fabric might be pressed so that the pattern duplication was not easily performed at imprinting. Therefore, pure water was sprayed onto the fabric to restore each strand into its original state. If the fabric was left for 10 minutes after the pure water was sprayed, each strand was restored into its original state.

If the strands of the surface of the fabric were restored into the original state, the surface of the fabric was evenly sprayed by a silicon releasing agent to apply it onto the whole surface of the fabric. After that, it was left in the air for 2 minutes so that the silicon releasing agent was permeated into the surface of the fabric. After being left for 5 minutes, the silicon releasing agent was again evenly applied onto the whole surface of the fabric. The pretreating was completed by leaving it in the air for 5 minutes so that the silicon releasing agent was permeated into the fabric.

Step of Nano-Imprinting the Pretreated Object to Polymer Sheet (S220)

After a Teflon sheet was seated on a lower template of the nano-imprinting apparatus, the object to be duplicated was put on the Teflon sheet, and then a polymer sheet having a thickness of 5 millimeters was put on the object to be duplicated. After the polymer sheet was seated, an upper template of the nano-imprinting apparatus was closed, and the initial pressure was set to 1 atm so that the object to be duplicated and the polymer sheet were fixed so as not to be moved. A heat plate was primarily heated by a temperature of 50° C. or less, and then after the pressure was set to 20 atm or less, the heat plate was secondarily applied by the pressure and heat for 4 hours. And then, it was cooled until the temperature was 25° C. or less, the upper template of the nano-imprinting apparatus was opened to take out and separate the object to be duplicated and the duplicate. Depending upon whether the object to be duplicated was pretreated or not, it was determined whether or not the polymer sheet with good pattern duplication could be obtained in the nano-imprinting process.

Step of Metalizing Surface of Nano-Imprinted Polymer Sheet (S230)

After the duplicated surface of the separated polymer sheet was sprayed by acetate acid for 10 seconds, pure water was sprayed onto the surface for 10 seconds to wash it. Then, the surface was activated by spraying colloid palladium onto the surface for 10 seconds, and then the pure water was sprayed onto the surface for 10 second to wash the surface.

The polymer with an activated surface was sprayed by a silver solution and a reducing agent for 10 seconds to form an Ag surface layer on the duplicated surface. The pure water was sprayed onto the surface for 10 seconds to wash the surface, and then the polymer sheet formed with the Ag surface layer was dried at a temperature of 60° C. for 15 minutes.

Step of Plating Polymer Sheet Having Metalized Surface to Manufacture Primitive Mold (S240)

The polymer sheet formed with the silver surface layer was attached to a cylindrical jig capable of easily applying an electric current. The silver surface layer of the polymer sheet was connected to the cylindrical jig by a copper tape in order to easily apply an electric current thereto. In order to form a metallic layer, the portion which does not need for plating was masked by a masking tape. After masking, the cylindrical jig attached by the polymer sheet was degreased by a metallic degreasing agent, and then was washed by the pure water. In this instance, the cylindrical jig had an outer diameter of 170 millimeters, an inner diameter of 130 millimeters, a thickness of 20 millimeters and a height of 105 millimeters, as shown in FIG. 1. The cylindrical jig was which was able to be coupled and decoupled in a radial direction by bolts at left and right sides of the cylindrical jig was used, so that the plated layer was formed and the inner periphery was planarized, the cylindrical jig was decoupled in the radial direction so easily separate the plated layer and the polymer sheet.

Then, the cylindrical jig attached with the polymer sheet having the silver surface layer was put in an electroplating cell, and then a power source was turned on. The electroplating was performed until the metallic plated layer had a thickness of 500 μm.

The plated cylindrical jig was put out from the plating cell, and was dried to manufacture a primitive mold including the cylindrical jig having the inner periphery with the plated layer.

Step of Planarizing Inner Periphery of Primitive Mold (S250)

The cylindrical jig having the inner periphery plated with the primitive mold was mounted to a lathe. The mounting of the cylindrical jig was carried out by using the fourth chuck of the lathe, and a bite of 0.8R was mounted to a tool rest having a bite holder. The inner periphery was machined by rotation at a constant rotational speed of 120 RPM. In this instance, the moving speed of the bit machining the plated layer of the inner periphery at a constant thickness was set to 0.1 mm/min for one lead. The machining was performed until the thickness of the inner periphery was 300 μm.

After the machining was completed, the cylindrical jig was removed from the lathe. The polymer sheet and the plated layer with machined inner periphery were separated from the cylindrical jig, and then the plated layer was removed from the polymer sheet to obtain an electroforming mold having the plated layer with a constant thickness. The electroforming mold was thermally shrunk to a dummy rolling roller to manufacture the rolling mold.

### Experiment Example 4

### Wood

Step of Pretreating Object to be Duplicated (S210)

Wood having a special pattern or design was selected as an object to be duplicated, and then was washed by dried air so as to eliminate dust or impurities from the surface of the wood. After washing, the surface of the wood was evenly sprayed by a silicon releasing agent to apply it onto the whole surface of the wood. After that, it was left in the air for 10 minutes so that the silicon releasing agent was permeated into the surface of the wood. After being left for 10 minutes, the silicon releasing agent was again evenly applied onto the whole surface of the wood. The pretreating was completed by leaving it in the air for 10 minutes so that the silicon releasing agent was permeated into the wood.

Step of nano-imprinting the pretreated object to polymer sheet (S220)

After a Teflon sheet was seated on a lower template of the nano-imprinting apparatus, the object to be duplicated was put on the Teflon sheet, and then a polymer sheet having a thickness of 5 millimeters was put on the object to be duplicated. After the polymer sheet was seated, an upper template of the nano-imprinting apparatus was closed, and the initial pressure was set to 1 atm so that the object to be duplicated and the polymer sheet were fixed so as not to be moved. A heat plate was primarily heated by a temperature of 50° C. or less, and then after the pressure was set to 20 atm or less, the heat plate was secondarily applied by the pressure and heat for 4 hours. And then, it was cooled until the temperature was 25° C. or less, the upper template of the nano-imprinting apparatus was opened to take out and separate the object to be duplicated and the duplicate. Depending upon whether the object to be duplicated was pretreated or not, it was determined whether or not the polymer sheet with good pattern duplication could be obtained in the nano-imprinting process.

Step of Metalizing Surface of Nano-Imprinted Polymer Sheet (S230)

After the duplicated surface of the separated polymer sheet was sprayed by acetate acid for 10 seconds, pure water was sprayed onto the surface for 10 seconds to wash it. Then, the surface was activated by spraying colloid palladium onto the surface for 10 seconds, and then the pure water was sprayed onto the surface for 10 second to wash the surface.

The polymer with an activated surface was sprayed by a silver solution and a reducing agent for 10 seconds to form an Ag surface layer on the duplicated surface. The pure water was sprayed onto the surface for 10 seconds to wash the surface, and then the polymer sheet formed with the Ag surface layer was dried at a temperature of 60° C. for 15 minutes.

Step of Plating Polymer Sheet Having Metalized Surface to Manufacture Primitive Mold (S240)

The polymer sheet formed with the silver surface layer was attached to a cylindrical jig capable of easily applying an electric current. The silver surface layer of the polymer sheet was connected to the cylindrical jig by a copper tape in order to easily apply an electric current thereto. In order to form a metallic layer, the portion which does not need for plating was masked by a masking tape. After masking, the cylindrical jig attached by the polymer sheet was degreased by a metallic degreasing agent, and then was washed by the pure water. In this instance, the cylindrical jig had an outer diameter of 170 millimeters, an inner diameter of 130 millimeters, a thickness of 20 millimeters and a height of 105 millimeters, as shown in FIG. 1. The cylindrical jig was which was able to be coupled and decoupled in a radial direction by bolts at left and right sides of the cylindrical jig was used, so that the plated layer was formed and the inner periphery was planarized, the cylindrical jig was decoupled in the radial direction so easily separate the plated layer and the polymer sheet.

Then, the cylindrical jig attached with the polymer sheet having the silver surface layer was put in an electroplating cell, and then a power source was turned on. The electroplating was performed until the metallic plated layer had a thickness of 500 μm.

The plated cylindrical jig was put out from the plating cell, and was dried to manufacture a primitive mold including the cylindrical jig having the inner periphery with the plated layer.

Step of Planarizing Inner Periphery of Primitive Mold (S250)

The cylindrical jig having the inner periphery plated with the primitive mold was mounted to a lathe. The mounting of the cylindrical jig was carried out by using the fourth chuck of the lathe, and a bite of 0.8R was mounted to a tool rest having a bite holder. The inner periphery was machined by rotation at a constant rotational speed of 120 RPM. In this instance, the moving speed of the bit machining the plated layer of the inner periphery at a constant thickness was set to 0.1 mm/min for one lead. The machining was performed until the thickness of the inner periphery was 300 μm.

After the machining was completed, the cylindrical jig was removed from the lathe. The polymer sheet and the plated layer with machined inner periphery were separated from the cylindrical jig, and then the plated layer was removed from the polymer sheet to obtain an electroforming mold having the plated layer with a constant thickness. The electroforming mold was thermally shrunk to a dummy rolling roller to manufacture the rolling mold.

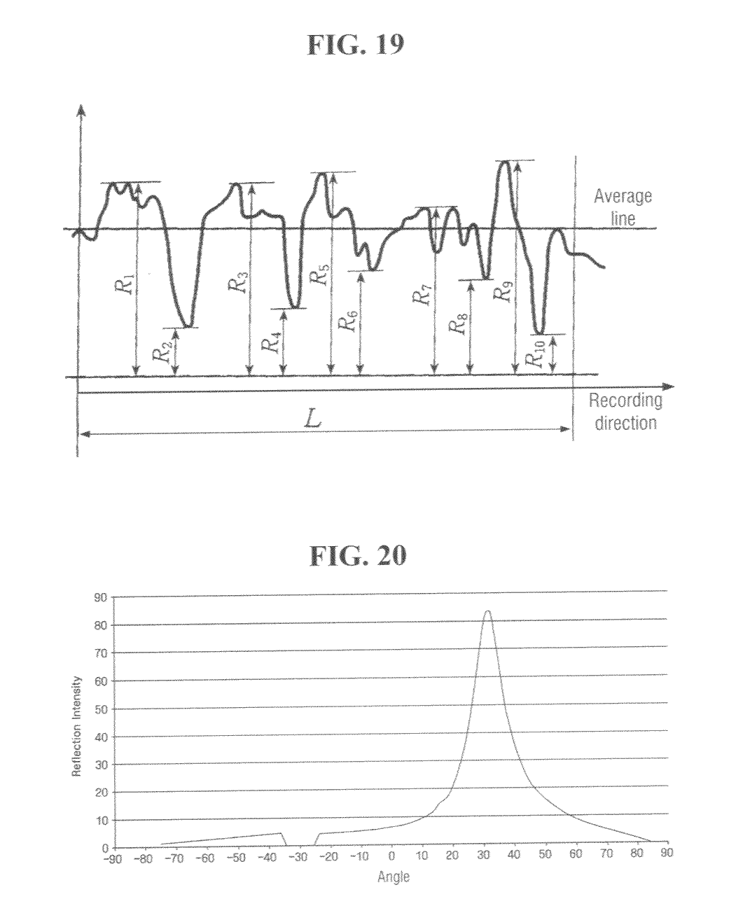

Now, a pattern-duplicated metal panel according to embodiments of the present invention will be now described with reference to FIGS. 18 to 20. FIG. 18 is a graph illustrating a curve of exemplary median average roughness (Ra). FIG. 19 is a graph illustrating a curve of exemplary ten-point average roughness (Rz). FIG. 20 is a graph illustrating a curve of exemplary photo reflection distribution.

The pattern 11 of the pattern duplicate 10 duplicated with the pattern 21 of the mold 20 can be defined by a surface roughness, a complication rate, and a photo reflection rate. First, the surface roughness is a value indicating a recessed degree of the surface of the object to be inspected, and is shown by median average roughness (Ra) and a ten-point average roughness (Rz).

First, the median average roughness (Ra) shows a curve of surface roughness (f(x)) corresponding to the recessed shape of the surface in an arbitrary length section, in which a cross section of the object to be inspected is corresponded to xy-coordinates and a recessed direction (thickness direction) of the object to be inspected is set as a y-axis, as shown in FIG. 18. After a center line (y=o) of the surface roughness curve (f(x)) is arbitrarily determined, a curved graph drawn by a curve up and down on the basis of the center line is shown. In order to obtain an area of the region which is formed by the curve and the center line, an absolute value of the surface roughness curve is integrated from 0 to L sections, and the integral value is divided by L to obtain an average value. The average value obtained by this method corresponds to the median average roughness (Ra).

The ten-point average roughness (Rz) shows a curve of surface roughness (g(x)) corresponding to the recessed shape of the surface in an arbitrary length section, in which a cross section of the object to be inspected is corresponded to xy-coordinates and a recessed direction (thickness direction) of the object to be inspected is set as a y-axis, as shown in FIG. 19. Unlike the graph in FIG. 18, a center line (y=o) becomes a bottom surface of the object to be inspected. Accordingly, the graph in which the cross section of the object to be inspected corresponds to xy coordinates is used. An average line is shown by obtaining an average height of the graph, and average values (S) of distances between the center line and 5 highest coordinates on the basis of the center line are added to average values (V) of distances between the center line and 5 lowest coordinates among coordinates which are lower than the center line to obtain the ten-point average roughness (Rz).

After the median average roughness (Ra) and the ten-point average roughness (Rz) are repeatedly performed in different regions of the object to be inspected, they are calculated as an average of the measured values. Such the surface roughness can be easily measured through a surface roughness measuring apparatus which can be commercially available.

The duplication rate is a value indicating how many patterns 21 of the mold 20 are duplicated to the pattern duplicate 10, and is shown by a percentage of the ten-point average roughness (Rz) of the mold 20 and the ten-point average roughness (Rz) of the pattern duplicate 10. That is, in the case where the pattern 21 of the mold 20 is completely duplicated, since the ten-point average roughness (Rz) of the pattern duplicate 10 is identical to the ten-point average roughness (Rz) of the mold 20, the duplication rate is represented by 100%.

The light reflectance rate is an optical property measured by a goniophotometer, and is represented by digitizing the result measured by the gloss of the object to be inspected. Specifically, light is irradiated onto the object to be inspected, and the intensity of the reflected light is measured. In this instance, the light is irradiated by changing an angle from −90° to 90°. Accordingly, the intensity of the light reflected at each angle can be measured, and the photo reflection graph as shown in FIG. 20 can be obtained. The intensity of the reflected light is represented by a relative ratio to the maximum reflection. The overall light reflection rate can be deducted by adding such the distribution. The optical reflection distribution can be schematically figured out through the graph of FIG. 20. Specifically, if the area of the graph is large and wide, the reflection is uniform as much as the area, and thus it means that the gloss value is large. In addition, if the photo reflection distribution graph of the pattern to be duplicated is identical to that of the pattern duplicate, it will be understood that it indicates the similar gloss degree.

As shown in Table 2 below, aluminum was a rolling material which becomes the pattern duplicate 10, and different kinds of aluminum were prepared according to Experiment Examples 5 to 11.

That is, Al 5042 having a thickness of 800 μm was used as the pattern duplicate 10 in Experiment Example 5, and a plurality of Al 3003 having different thicknesses of 400 μm, 560 μm and 700 μm were used as the pattern duplicate 10 in Experiment Examples 6 to 8. Al 1050 having a thickness of 500 μm was used as the pattern duplicate 10 in Experiment Example 9, and Al 1235 having a thickness of 800 μm was used as the pattern duplicate 10 in Experiment Example 11.

TABLE 2

| | Experiment example | | | | | | | | | | | | | |
|---|---|---|---|---|---|---|---|---|---|---|---|---|---|---|
| | 5 | | 6 | | 7 | | 8 | | 9 | | 10 | | 11 | |
| Kind of Al | 5052 | | 3003 | | 3003 | | 3003 | | 1050 | | 8079 | | 1235 | |
| Thickness of | 800 | μm | 400 | μm | 560 | μm | 700 | μm | 500 | μm | 700 | μm | 800 | μm |
| Al | | | | | | | | | | | | | | |
| Hardness of | 63.40 | Hv | 38.90 | Hv | 39.20 | Hv | 41.70 | Hv | 33.50 | Hv | 24.80 | Hv | 23.40 | Hv |
| Al | | | | | | | | | | | | | | |
| Rolling | 2.56 | t | 2.15 | t | 2.27 | t | 3.2 | t | 2.7 | t | 3.05 | t | 2.85 | t |
| pressure | | | | | | | | | | | | | | |

| | | | | | | | |
|---|---|---|---|---|---|---|---|
| Rz | 19.08 | 21.88 | 22.96 | 26.00 | 26.78 | 29.19 | 35.60 |
| measurement | | | | | | | |
| Duplication | 41.52% | 47.64% | 49.98% | 56.58% | 58.29% | 63.53% | 77.47% |
| rate | | | | | | | |
| Light | 15597 | 16859 | 14638 | 20660 | 18649 | 24981 | 22994 |
| reflection | | | | | | | |
| rate | | | | | | | |

The ten-point average roughness (Rz) of the pattern duplicate 10 obtained under the conditions of Experiment Examples 5 to 11 had a value in the range of 19.08 to 35.60. In particular, the value of the ten-point average roughness in Experiment Example 11 was highly measured. The reason is that the hardness of the Al 1235 was lower than that of aluminums used in other Experiment Examples. The pattern duplication rate was represented by a percentage of the ten-point average roughness of the pattern 21 of the mold 20. If the duplication rate is 100%, it means that the mold pattern 21 is completely duplicated to the pattern duplicate 10. Since the ten-point average roughness of the mold patterns 21 used in Experiment Examples 5 to 11 was 45.95, the duplication rate was calculated based on the ten-point average roughness, that is, had a value in the range of 41.52% to 77.47%.

Meanwhile, the light reflection rate in Experiment Examples 5 to 11 had a range of 14638 to 24981. The light reflection rate of the silk fabric which was the object to be duplicated in Experiment Examples 5 to 11 was 40000 or more as shown in Table 3 below.

TABLE 3

| | Overall average | Positive portion | Negative portion |
|---|---|---|---|
| Kind | of fabric | of fabric | of fabric |
| Light reflection rate | 46,160 | 49,990 | 40,668 |

The pattern duplicate 10 had the light reflection rate of 31.7% to 54.1% relative to that of the object 30 to be duplicated. As described above, the light reflection rate digitizes objectively the inherent gloss of the pattern 31 of the object 30 to be actually duplicated. The light reflection rate was half or less relative to that of the object 30 to be duplicated. Since the lost light reflection rate was compensated by the inherent gloss of the metal, the gloss of the object 30 to be duplicated could be represented on the surface of the object 10 to be duplicated at the same or more.

Next, as shown in Table 4 below, Experiment Examples in which the rolling materials which become the pattern duplicate 10 were magnesium will be described. In the case of magnesium, AZ31B-O was used, and two types having a thickness of 1000 μm and 2000 μm were tested.

TABLE 4

| | Experiment Example | | | |
|---|---|---|---|---|
| | 12 | 13 | 14 | 15 |
| Thickness of Mg | 1000 μm | 1000 μm | 1000 μm | 2000 μm |
| Rolling gap | 40% | 30% | 20% | 40% |
| Rolling pressure | 2.8 t | 3.4 t | 3.9 t | 4.9 t |
| Ra measurement | 4.06 | 4.33 | 4.80 | 4.59 |
| Rz measurement | 17.31 | 18.85 | 19.97 | 19.43 |
| Duplication rate | 61.4% | 66.8% | 70.8% | 68.9% |
| (Rz) | | | | |
| Light reflection rate | 40394 | 44188 | 42907 | 40300 |

The thickness of the mold 20 used in Experiment Examples 12 to 15 was 400 μm, and the rolling gap means a ratio of the rolling gap to the overall thickness of the mold 20 and the thickness of the rolling materials, as described above. For example, the thickness of a magnesium panel was 1000 μm, and the thickness of the mold was 400 μm, in Experiment Example 12. Therefore, the overall thickness was 1400 μm, and it was 40%, so that the gap of the rolling rollers could be set as 560 μm in Experiment Example 12. As can be known from Table 4, as the rolling gap is narrow relative to the overall thickness, the rolling pressure applied to the rolling material is increased.

In Experiment Examples 12 to 14, the median average roughness (Ra) in Experiment Examples 12 to 14 is in the range of 4.06 to 4.80, and the ten-point average roughness (Rz) is in the range of 17.31 to 19.97.

In other words, it will be understood that since as the gap of the rolling rollers is narrow the rolling pressure is increased, the values of the median average roughness and the ten-point average roughness are relatively increased. After all, it will be also understood that the duplication rate is increased. However, if the gap of the rolling rollers is narrow, the pressure applied to the rolling rollers is remarkably increased. Therefore, the energy required to maintain the pressure is increased, and thus a production cost is also increased. If the applied exterior force exceeds a threshold value, the pattern duplicate 10 can be damaged. Accordingly, it is preferable to appropriately set the gap of the rolling rollers in the range indicating that the pattern of the pattern duplicate 10 shows the wanted gloss, in view of the hardness of the rolling material.

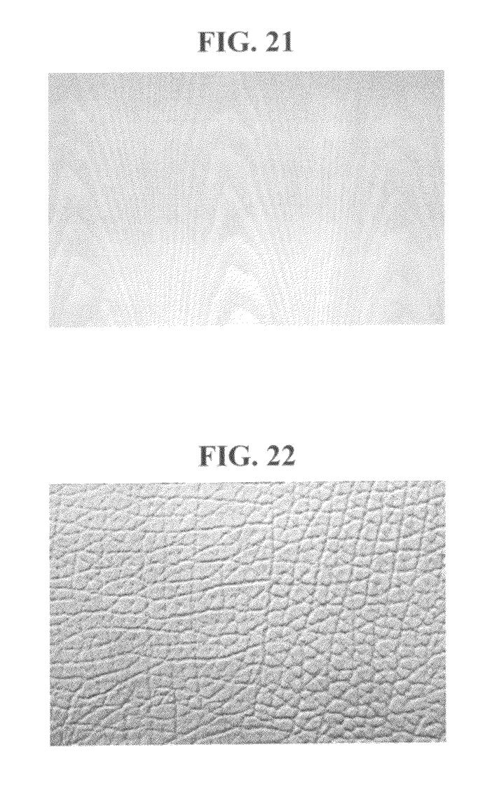

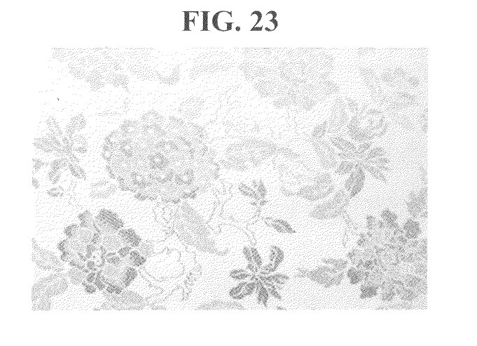

With reference to FIGS. 21 to 23, there are shown actual photographs of the pattern duplicates 10. FIG. 21 is a photograph of a pattern-duplicated metal panel duplicated with a pattern of wood's surface according to an embodiment of the present invention. FIG. 22 is a photograph of a pattern-duplicated metal panel duplicated with a pattern of leather's surface according to an embodiment of the present invention. FIG. 23 is a photograph of a pattern-duplicated metal panel duplicated with a pattern of silk's surface according to an embodiment of the present invention.

As shown in FIGS. 21 to 23, according to the pattern-duplicated metal panels 10 having the above properties, the surface thereof is formed with the wanted pattern, specifically, the pattern of nano scale or micro scale to improve its value and applicability. Since the repeated duplication can be achieved by use of the mold 20, there is an advantage of manufacturing a plurality of duplicates at low cost. In addition, since the pattern of the object 30 to be duplicated can be duplicated at high precision, it is possible to duplicate the pattern precisely.

While the present invention has been particularly shown and described with reference to exemplary embodiments thereof, it will be understood by those of ordinary skill in the art that various changes in form and detail may be made therein without departing from the spirit and scope of the present invention as defined by the following claims and equivalents thereof. The exemplary embodiments should be considered in a descriptive sense only and not for purposes of limitation.

What is claimed is:

1. A method of duplicating a pattern texture of a surface of an object, comprising:
a) selecting the object having the surface texture to be duplicated;
b) disposing the selected object and pretreating a surface thereof;
c) nano-imprinting the surface of the pretreated object to duplicate it on a sheet;
d) Metalizing a surface of the sheet through electroforming to manufacture a metal module master mold;
e) trimming an edge of the metal module master mold, performing micro-processing and connecting the metal module master mold, and performing electroforming the connected metal module master mold to manufacture a large-area metal unit master mold; and
f) electroforming the metal unit master mold to produce a duplicate having the surface texture or performing rolling to produce a duplicate having the surface texture by the rolling roller having the metal unit master mold.

2. The method according to claim 1, wherein, in the step a, the object is selected from natural materials including plants, woods, mineral and insects, and artificial materials including leathers, woven fabric, and artwork.

3. The method according to claim 1, wherein, in the step b, the pretreating comprises subjecting the surface of the selected object to washing, drying and then nano-thin film treatment to block transfer of impurities so as to facilitate separation of a nano-imprint mold.

4. The method according to claim 1, wherein, in the step d, the metalizing further comprises subjecting the surface of the mold to either spraying or wet silver curing.

5. The method according to claim 1, wherein, in the step e, the micro-processing comprises scanning the surface of the object to be duplicated to set a predetermined standard pattern for connection of the molds and then performing two-dimensional or three-dimensional micro-processing.

6. The method according to claim 1, wherein, in the step e, the metal unit master mold is manufactured by trimming the edge of the module master mold, and connecting trimmed portions, which are subjected to two-dimensional or three-dimensional processing, of the module master molds.

7. The method according to claim 1, wherein the step f produces a surface duplicate by metal or plastic.

8. The method according to claim 7, wherein the plastic comprises a substrate, and a resin layer on the substrate which consist of at least one selected from a nitrocellulose, a thermoset, and a thermoplastic, and
wherein the surface texture is formed on the resin layer.

9. A method of duplicating a pattern texture of a surface of an object, comprising:
a) manufacturing a rolling mold having a width of 10 centimeters to 120 centimeters and a circumferential length of 10 centimeters to 240 centimeters, with a surface thereof formed with a micro pattern;
b) mounting the rolling mold to a rolling roller;
c) measuring a thickness of a metal sheet, and setting a gap of the rolling rollers in such a way that a pitch of the micro pattern is 5 μm to 20 mm, and a depth is 1 μm to 330 μm; and
d) performing rolling of the metal sheet by the rolling roller under the set gap of the rolling roller

10. The method according to claim 9, wherein the step c further comprises making the width of the rolling mold coincide with that of the metal sheet.

11. The method according to claim 9, wherein a variation in thickness of the metal sheet before and after rolling in the step d is 10% or less.

12. The method according to claim 9, wherein a rolling pressure in the step d is 1 ton to 10 tons.

13. The method according to claim 9, wherein a rolling speed in the step d is 0.1 m/min to 10 m/min.

14. The method according to claim 9, wherein the rolling mold is plated by at least one selected from a group consisting of nickel, copper, iron and its alloy.

15. The method according to claim 9, wherein the gap of the rolling roller has a value in the range of 10% to 50% of the whole thickness of the rolling mold and the metal sheet.

16. A metal panel including a surface with a micro pattern or design, wherein ten-point average roughness (Rz) of the micro pattern or design formed on the surface is 10 μm to 40 μm.

17. A metal panel including a surface with a micro pattern or design, wherein median average roughness (Ra) of the micro pattern or design formed on the surface is 3 μm to 8 μm.

18. A metal panel including a surface with a micro pattern or design, wherein ten-point average roughness (Rz) of the micro pattern or design formed on the surface is 10 μm to 40 μm, and median average roughness (Ra) of the micro pattern or design formed on the surface is 3 μm to 8 μm.

19. The metal panel according to claim 18, wherein a light reflection rate from the micro pattern or design formed on the surface is 10000 to 45000.

20. The metal panel according to claim 18, wherein the micro pattern or design of the metal panel is formed by duplication of a micro pattern or design formed on a surface of a mold, and ten-point average roughness (Rz) of the micro pattern or design of the metal panel is 40% or more of that of the micro pattern or design of the mold.
